(19) United States
(12) Patent Application Publication
(10) Pub. No.: US 2026/0175588 A1
(43) Pub. Date: Jun. 25, 2026

(54) CASE FOR A PRINTER CARTRIDGE AND MANUFACTURING METHOD

(71) Applicant: Videojet Technologies Inc., Wood Dale, IL (US)

(72) Inventors: Qaisar Imran, Wood Dale, IL (US); Peter Nguyen, Wood Dale, IL (US); Yong Wang, Wood Dale, IL (US)

(73) Assignee: Videojet Technologies Inc., Wood Dale, IL (US)

(21) Appl. No.: 19/125,823

(22) PCT Filed: Nov. 6, 2023
(86) PCT No.: PCT/US2023/036854

§ 371 Date: Apr. 30, 2025

Related U.S. Application Data
(60) Provisional application No. 63/423,352, filed on Nov. 7, 2022.

(51) Int. Cl. B41J 2/175

(52) U.S. Cl. CPC B41J 2/1752; B41J 2/17509; B41J 2/17513; B41J 2/17553

(57) ABSTRACT

A case for a cartridge of a printer is disclosed. The case includes: a plurality of walls defining a bladder volume configured to receive a bladder of the cartridge and a neck interface of a front wall of the plurality of walls. The neck interface defines a neck aperture configured to receive a neck of the bladder. The case is a single continuous piece of material.

### CROSS-REFERENCE TO RELATED PATENT APPLICATION

This application claims the benefit of and priority to U.S. Provisional Application No. 63/423,352, filed on Nov. 7, 2022, the entire disclosure of which is hereby incorporated by reference herein.

### TECHNICAL FIELD

The present disclosure relates generally to printers. More specifically, the present disclosure relates to cartridges containing fluids, such as ink and/or solvent, for use by printers.

### BACKGROUND

Printers utilize various fluids throughout operation, such as ink for marking a desired pattern and solvent to be mixed with the ink. These fluids are contained in cartridges that facilitate storage and transportation of the fluids. The cartridges include interfaces that facilitate transferring the fluid to a printer. When the fluid within a cartridge is depleted, the cartridge may be removed from a printer and replaced with another full cartridge.

### SUMMARY

One example embodiment relates to a case for a cartridge of a printer. The case includes: a plurality of walls defining a bladder volume configured to receive a bladder of the cartridge and a neck interface of a front wall of the plurality of walls. The neck interface defines a neck passage configured to receive a neck of the bladder. The case is a single continuous piece of material.

Another example embodiment relates to a method of manufacturing a cartridge for a printer. The cartridge has a case defining a bladder volume and includes a neck aperture positioned on a first side of the case. The cartridge also has a bladder including a main body configured to hold a fluid and having a neck coupled to the main body. The method includes: positioning the bladder such that the neck extends through the neck aperture and the main body extends within the bladder volume, and moving at least one member of the case proximate the neck aperture away from the neck during the positioning. The case may be a single continuous piece of material. The method may further include offsetting a lower portion of the first side of the case relative to at least a part of a remaining portion of the first side of the case. The offset may define a relief volume such that, in use, built-up fluid (e.g., dripped ink) or debris may be trapped in a volume defined between the cartridge and a cartridge receiver for the printer and not adversely affect insertion of new cartridges into the cartridge receiver.

Yet another embodiment relates to a single component case for a cartridge of a printer. The single component case includes a plurality of walls defining a bladder volume configured to receive a bladder of the cartridge and a neck interface of a front wall of the plurality of walls. The neck interface defines a neck aperture configured to receive a neck of the bladder.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a block diagram of a printer, according to an exemplary embodiment.

FIG. 2 is a perspective view of a cartridge of the printer of FIG. 1, according to an exemplary embodiment.

FIG. 3 is another perspective view of the cartridge of FIG. 2.

FIG. 4 is an exploded perspective view of the cartridge of FIG. 2 including a case, a bladder, and a storage card.

FIG. 5 is an exploded perspective view of the bladder of FIG. 4.

FIG. 6 is a right section view of an interaction between a needle of the printer of FIG. 1 and the bladder of FIG. 4.

FIG. 7 is a perspective view of the cartridge of FIG. 2 with the bladder of FIG. 4.

FIGS. 8 and 9 are perspective views of the cartridge of FIG. 2 with the case of FIG. 4 and alternative bladders of various sizes, according to exemplary embodiments.

FIG. 10 is a perspective view of the storage card of FIG. 4.

FIG. 11 is a perspective view of the cartridge of FIG. 2 filled with fluid, according to an exemplary embodiment.

FIG. 12 is a perspective view of the cartridge of FIG. 2 engaged with a cartridge receiver of the printer of FIG. 1, according to an exemplary embodiment.

FIG. 13 is a perspective view of the printer of FIG. 1 with the cartridge of FIG. 2 and the cartridge receiver of FIG. 12.

FIG. 14 is a front section view illustrating an engagement between the cartridge of FIG. 2 and the cartridge receiver of FIG. 12, according to an exemplary embodiment.

FIG. 15A is a perspective view of another cartridge, according to an exemplary embodiment.

FIG. 15B is a perspective view of the cartridge of FIG. 15A.

FIG. 16 is a top section view illustrating engagement between the cartridge of FIG. 2 and the cartridge receiver of FIG. 12.

FIG. 17 is a right section view illustrating the engagement between the cartridge of FIG. 15A and the cartridge receiver of FIG. 12.

FIG. 18 is a detail perspective view of the cartridge of FIG. 2.

FIG. 19 is a right section view of the cartridge of FIG. 2.

FIG. 20A is a perspective view of the cartridge of FIG. 2.

FIG. 20B is a top perspective section view of the cartridge of FIG. 2.

FIG. 20C is a right section view of the cartridge of FIG. 2.

FIG. 21 is a perspective view of another cartridge, according to an exemplary embodiment.

FIG. 22A is a perspective view of the cartridge of FIG. 21.

FIG. 22B is a top perspective section view of the cartridge of FIG. 21 including the storage card and the bladder of FIG. 4.

FIG. 22C is a right section view of the cartridge of FIG. 21.

FIG. 23 is a perspective view of a package for the cartridge of FIG. 2 in an open configuration, according to an exemplary embodiment.

FIG. 24 is a perspective view of the package of FIG. 23 in a closed configuration, according to an exemplary embodiment.

FIGS. 25-29 are perspective views of neck interfaces for cartridges, according to various additional exemplary embodiments.

FIGS. 30-36 are perspective views of storage card interfaces for cartridges, according to various additional exemplary embodiments.

FIGS. 37-47 are perspective views of cartridges of the printer of FIG. 1, according to various additional exemplary embodiments.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### System Overview

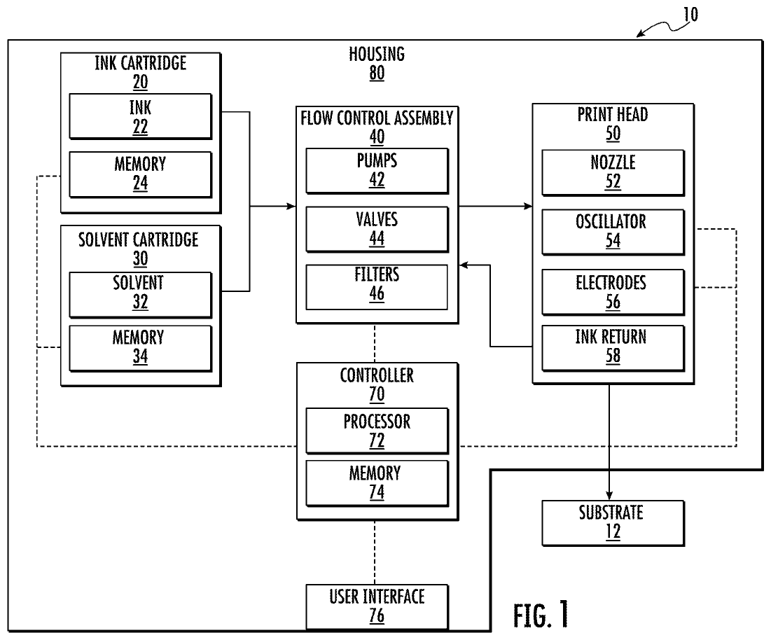

Referring now to FIG. 1, a printer or printer system 10 is shown according to an exemplary embodiment. In some embodiments, the printer 10 is an industrial continuous inkjet printer. For example, the printer 10 may be disposed in a factory (e.g., on a manufacturing floor) and/or in other desired locations. The printer 10 may deposit a fluid, such as ink, on a substrate 12 (e.g., plastic, metal, paper, etc.) in a desired pattern. The pattern produced by the printer 10 may represent information pertaining to a product that includes the substrate 12, such as an expiration date of the product, a serial number of the product, and/or information related to the fabrication of the product (e.g., a production date of the product, a batch number of the product, a location where the product was produced, etc.). In some embodiments, the printer 10 remains stationary and marks products that move passed the printer at regular intervals (e.g., on a conveyor belt). The printer 10 may be used to mark various types of products, such as containers (e.g., bottles, cans, pouches, etc. for containing food, beverages, industrial liquids, etc.), cables, pipes, foils, or other products. In other embodiments, the printer 10 is a different type of printer.

The printer includes a pair of cartridges, containers, vessels, canisters, or capsules, shown as ink cartridge 20 and solvent cartridge 30. The ink cartridge 20 contains a volume of marking fluid (e.g., printer ink), shown as ink 22. The ink cartridge 20 includes a memory device or storage device (e.g., a printed circuit board), shown as memory 24. The solvent cartridge 30 contains a volume of make-up fluid, shown as solvent 32. The solvent 32 may be mixed with the ink 22 (e.g., to control a property of the ink 22, such as viscosity). By way of example, the ink 22 may initially include a volume of solvent that evaporates over time. The solvent 32 may be added to the ink 22 to restore the solvent that is lost. Additionally or alternatively, the solvent 32 may be used to clean the ink 22 from components of the printer 10 (e.g., the print head 50). The solvent cartridge 30 includes a memory device or storage device (e.g., a printed circuit board), shown as memory 34.

The memory 24 and the memory 34 may be used to store and communicate various information regarding the ink cartridge 20 and the solvent cartridge 30, respectively. By way of example, the memory 24 may store information such as the type of ink within the ink cartridge 20, the volume of ink within the ink cartridge 20, and/or parameters describing characteristics of the ink 22 (e.g., viscosity, age, a desired amount of solvent within a given volume of ink 22, etc.). By way of example, the memory 34 may store information such as the type of solvent within the solvent cartridge 30, the volume of solvent within the solvent cartridge 30, and/or parameters describing characteristics of the solvent 32. In some embodiments, the memory 24 and/or the memory 34 are rewriteable. By way of example, in response to receiving a signal (e.g., from the controller 70) indicating an amount of the ink 22 and/or the solvent 32 that has been consumed, the memory 24 and/or the memory 34 may update the stored value representing the volume of fluid remaining in the respective cartridge.

The printer 10 further includes a fluid control circuit or hydraulic circuit, shown as flow control assembly 40. The flow control assembly 40 is fluidly coupled to the ink cartridge 20 and the solvent cartridge 30. The flow control assembly 40 is configured to manage (e.g., control, direct, etc.) the flow of fluids (e.g., the ink 22 and/or the solvent 32) throughout the printer 10. The flow control assembly 40 may control the flow direction, the flow rate, and/or mixing of the fluids. As shown in FIG. 1, the paths of fluid flow throughout the printer 10 are generally represented by solid lines.

The flow control assembly 40 includes one or more pumps 42 that drive the flow of fluids throughout the printer 10. By way of example, a first pump 42 may draw the ink 22 from the ink cartridge 20, and a second pump 42 may draw the solvent 32 from the solvent cartridge 30. One or more valves (e.g., directional control valves, solenoid valves, etc.), shown as valves 44, may control the flow direction, flow rate, and/or mixing of the fluids. The flow control assembly 40 may include one or more filters 46 to remove contaminants from the fluids.

Referring still to FIG. 1, the printer 10 may include a print head 50 that distributes the ink 22 onto the substrate 12 in the desired pattern. The ink 22 may be pressurized by the pumps 42 and provided to a flow restriction, shown as nozzle 52, that directs the flow of ink 22 toward the substrate 12. The print head 50 includes an oscillator or vibrator (e.g., a piezoelectric oscillator), shown as oscillator 54, that causes the ink 22 to separate into smaller volumes or droplets. The droplets pass by or more charging elements, shown as electrodes 56. The electrodes 56 may electrostatically charge one or more of the droplets, depending upon the desired pattern to be provided by the printer 10. The electrodes 56 permit a first subset (e.g., one or more) of the droplets having a first charge level to pass toward the substrate 12 and create the desired pattern. A second subset of the droplets having a second charge level are deflected by the electrodes 56 and are captured by a gutter, shown as ink return 58, prior to reaching the substrate 12. The ink return 58 returns the captured portion of the ink 22 to the flow control assembly 40 for subsequent use by the printer 10. The flow control assembly 40 may supply additional solvent 32 to the captured portion of the ink 22 to make up for any solvent that is lost (e.g., evaporated) when the ink 22 is exposed to air.

The printer 10 may include one or more controllers, shown as controller 70, that control operation of the printer 10. The controller 70 includes one or more processors, shown as processor 72 coupled to one or more memory devices, shown as shown as memory 74. The memory 74 may contain instructions that, when executed by the processor 72, cause the controller 70 to perform the various processes described herein. The controller 70 is operatively coupled to the ink cartridge 20, the solvent cartridge 30, the flow control assembly 40, and the print head 50. The controller 70 is configured to send signals (e.g., electrical energy, information, data, etc.) to and/or receive signals from the ink cartridge 20, the solvent cartridge 30, the flow control assembly 40, and the print head 50. As shown in FIG. 1, the signals are represented as dashed lines. The controller 70 may control operation of the memory 24, the memory 34, the pumps 42, the valves 44, the oscillator 54, and/or the electrodes 56 to facilitate the printing process.

As shown in FIG. 1, the printer 10 includes an input/output device, shown as user interface 76, operatively coupled to the controller 70. The user interface 76 may facilitate providing information from the controller 70 to a user and/or providing information (e.g., commands) from a user to the controller 70. The user interface 76 may include input devices (e.g., touchscreens, keyboards, mice, buttons, switches, microphones, etc.) and/or output devices (e.g., displays, speakers, lights, haptic feedback devices, etc.). A user may utilize the user interface 76 to review and/or edit one or more settings that control operation of the printer 10. By way of example, the user interface 76 may facilitate user control over the content and arrangement of the desired pattern produced by the printer 10.

The printer 10 further includes a housing, casing, or chassis, shown as housing 80. The housing 80 supports the other components of the printer 10. In some embodiments, one or more of the other components of the printer 10 are at least partially enclosed within the housing 80.

### Cartridge

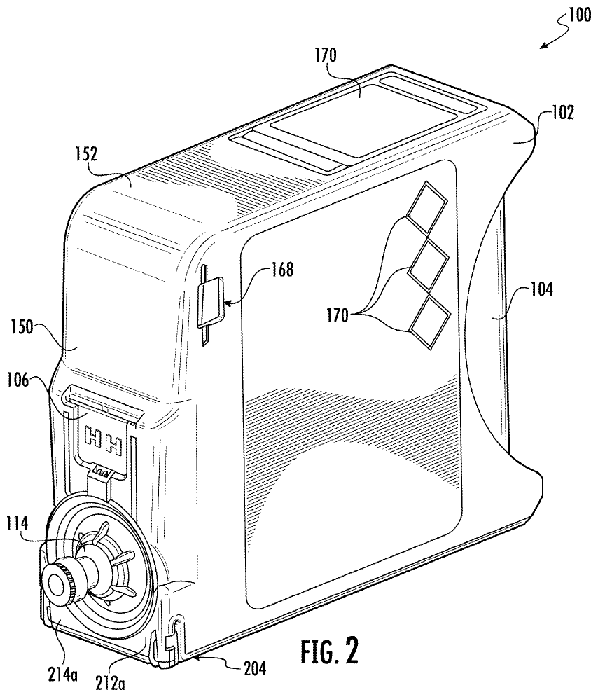

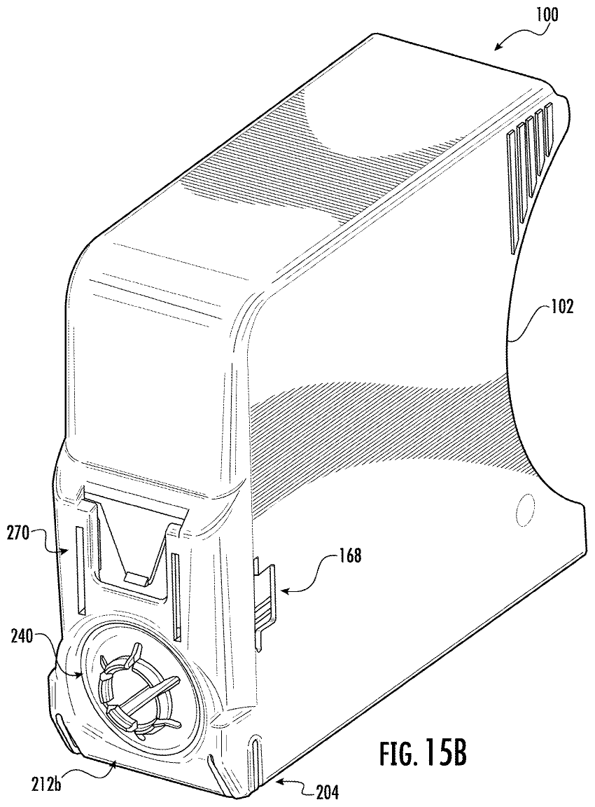

Referring to FIGS. 2-4 in combination with FIG. 1, a cartridge, container, vessel, canister, or capsule, is shown as cartridge 100. FIGS. 15A and 15B depict a variation of the cartridge 100 relative to the cartridge in FIGS. 2-4, 7-9, and 18-23. The cartridge 100 of FIGS. 15A and 15B is substantially similar, in structure and function, to the cartridge 100 in FIGS. 2-4, 7-9, and 18-23 except for including a relatively larger/more pronounced relief area for captured fluid, particles, and/or a combination thereof described herein. This is shown by surfaces 212a of the case 102 of FIGS. 2 and 212b of the case 102 of FIGS. 15A and 15B. In one embodiment, the cartridge of FIG. 2 is used with a different printer relative to the cartridge of FIGS. 15A and 15B. In another embodiment, the cartridges of FIGS. 2 and FIGS. 15A and 15B are used with the same type of printer. Therefore, the description contained below and herein regarding the cartridge of FIG. 2 is equally applicable to that of FIGS. 15A and 15B except as otherwise described herein.

The cartridge 100 may represent the ink cartridge 20, the solvent cartridge 30, and/or another cartridge for a different printer or another application. By way of example, the ink cartridge 20 and the solvent cartridge 30 may be structurally similar, but filled with different fluids. Accordingly, any description with respect to the cartridge 100 may apply to the ink cartridge 20 and/or the solvent cartridge 30 except as otherwise specified.

In some embodiments, the cartridge 100 is configured to be replaced and disposed of when emptied. Accordingly, the cartridge 100 may be removably coupled to the housing 80 to facilitate replacement. One or more components of the cartridge 100 may be recyclable. In other embodiments, the cartridge 100 is refillable.

The cartridge 100 includes an outer housing, casing, enclosure, or protective cover, shown as case 102. The case 102 supports at least one other component of the cartridge 100. The case 102 may provide an interface that facilitates removably coupling the cartridge 100 to the housing 80 of the printer 10 (e.g., to facilitate removal of the cartridge 100 when emptied). In some embodiments, the case 102 is formed from a relatively stiff or rigid material (e.g., a hard plastic). By way of example, the case 102 may be injection molded from plastic.

The cartridge 100 further includes a liner, container, vessel, or reservoir, shown as bladder 104. The bladder 104 is configured to contain a volume of fluid (e.g., the ink 22, the solvent 32, etc.). The bladder 104 is coupled to the case 102. The bladder 104 may be at least partially enclosed by the case 102. In some embodiments, the bladder 104 is formed from a relatively flexible material (e.g., an elastomer). By way of example, the bladder 104 may be relatively more flexible than the case 102. By forming the bladder 104 from a flexible material, the bladder may expand to facilitate filling the bladder 104 with fluid or contract to facilitate expelling fluid from the bladder 104.

The cartridge 100 further includes a memory device (e.g., a printed circuit board), shown as storage card 106. The storage card 106 is configured to store and communicate various information regarding the cartridge 100 with the controller 70. By way of example, the storage card 106 may act as the memory 24 and/or the memory 34.

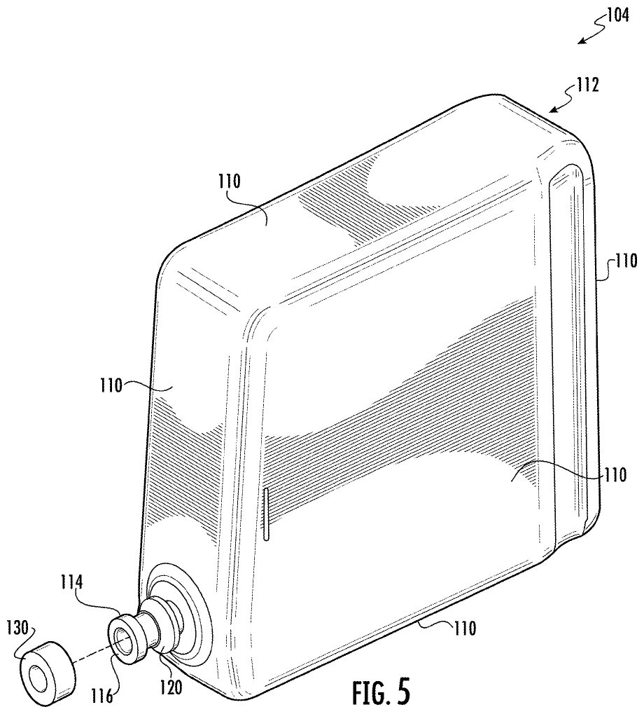

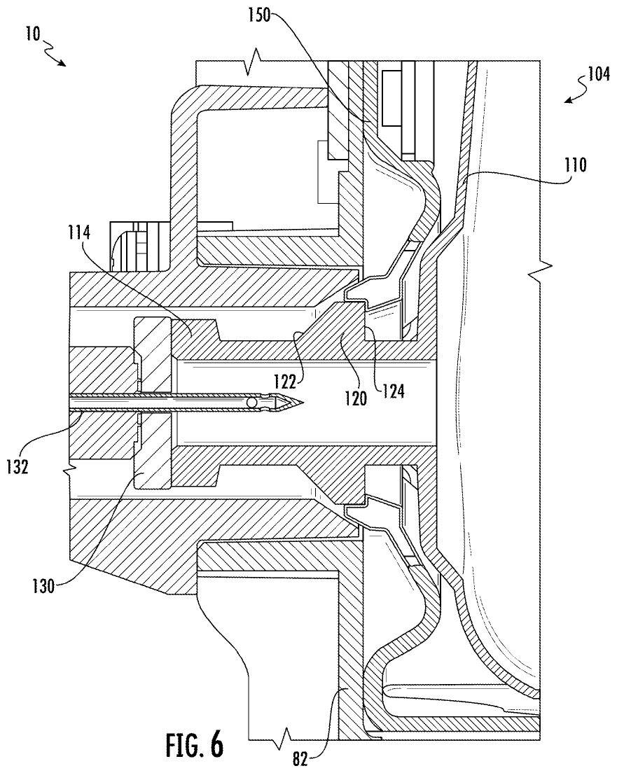

Referring to FIGS. 5 and 6, the bladder 104 is shown according to an exemplary embodiment. The bladder 104 includes a series of walls 110 that form a main body 112 that is generally rectangular. In other embodiments, a different shape may be utilized (e.g., spherical, conical, etc.). The walls 110 define a fluid storage volume containing the fluid of the bladder 104. Extending longitudinally forward from the main body 112 is a protrusion, shown as neck 114. An outlet passage or fluid transfer passage or channel, shown as passage 116, extends substantially longitudinally through the neck 114 and a front-most wall 110 of the main body 112. The passage 116 may be axially or substantially axially aligned with the neck 114. The passage 116 is fluidly coupled to the fluid storage volume of the main body 112 thereby permitting fluid to enter and exit the main body 112 volume through the passage 116.

The neck 114 includes an annual protrusion or projection, shown as shoulder 120, that extends radially outward. The shoulder 120 may be integrally formed with the rest of the neck 114 and the main body 112 as a single, continuous piece. The shoulder 120 has a front surface, shown as tapered surface 122, facing away from the main body 112. The tapered surface 122 may be frusto-conical and oriented such that a diameter of the tapered surface 122 increases as the tapered surface 122 extends toward the main body 112. The shoulder 120 has a rear surface, shown as engagement surface 124, facing toward the main body 112. The engagement surface 124 extends substantially perpendicular to the passage 116. The shoulder 120 includes an outer circumference or annular surface, shown as outer surface 126. The outer surface 126 is substantially cylindrical and extends between the tapered surface 122 and the engagement surface 124.

The bladder 104 further includes a sealing member, shown as seal 130, fixedly coupled to a distal end of the neck 114 (i.e., an end of the neck 114 away from the main body 112). The seal 130 extends across the passage 116, fluidly decoupling the fluid storage volume of the main body 112 from the flow control assembly 40 of the printer 10 and sealing or substantially sealing the fluid within the bladder 104. The printer 10 includes a puncture member, shown as needle 132, positioned to engage the seal 130 when the cartridge 100 is placed within the housing 80 of the printer 10. Upon engagement, the needle 132 punctures the seal 130, permitting fluid to flow out of the bladder 104 and into the flow control assembly 40.

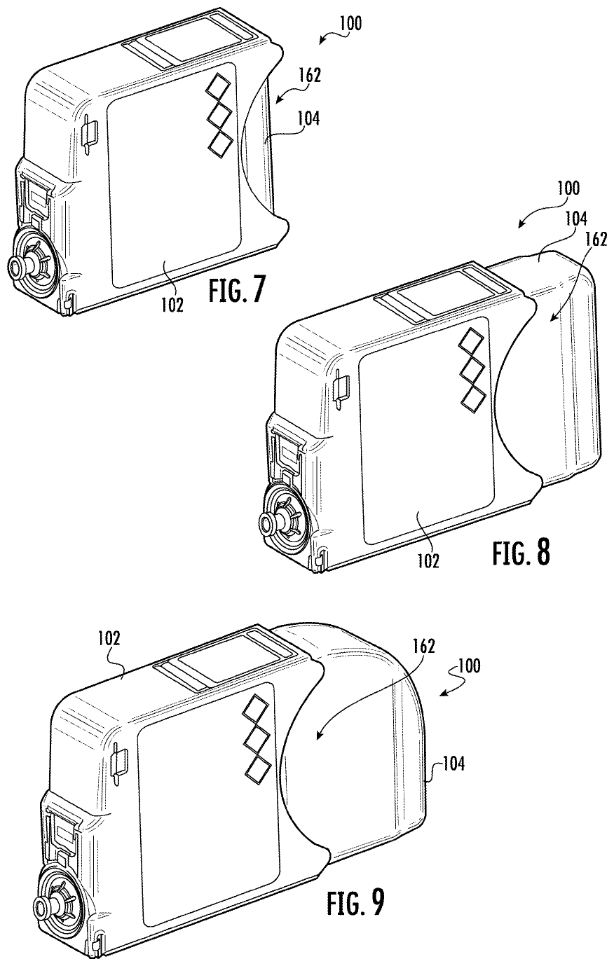

Referring to FIGS. 7-9, the cartridge 100 may utilize a variety of differently-sized bladders 104, each bladder 104 being configured to contain a variety of different volumes of liquid. In the embodiment of FIG. 7, the bladder 104 is sized to contain 750 mL of fluid. In the embodiment of FIG. 8, the bladder 104 is sized to contain 900 mL of fluid. In the embodiment of FIG. 9, the bladder 104 is sized to contain 1000 mL of fluid. As indicated above, the size, shape, and overall look of the bladder 104 may change based on the application.

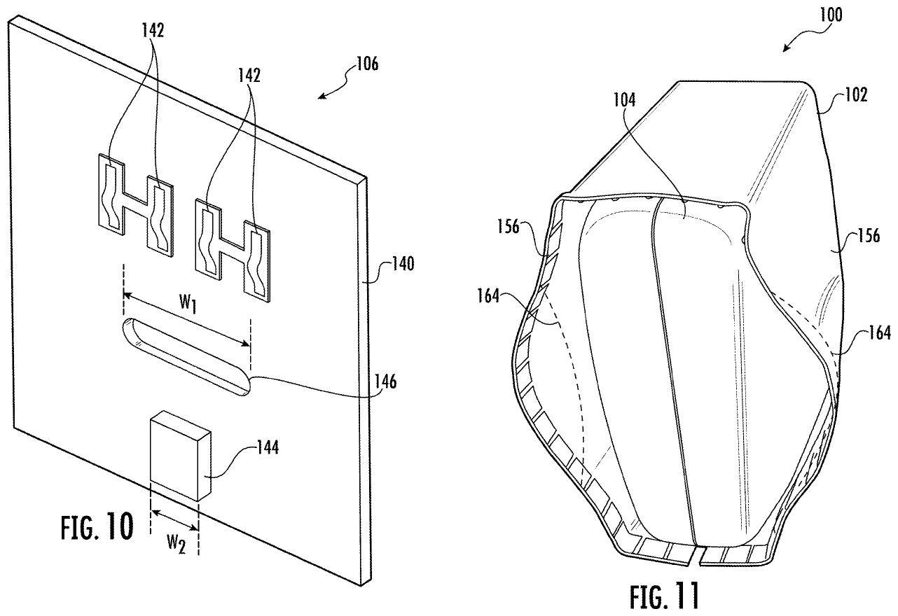

Referring now to FIG. 10, the storage card 106 is shown according to an exemplary embodiment. The storage card 106 includes a base or substrate, shown as board substrate 140, that supports and couples the various components of the storage card 106. In some embodiments, the board substrate 140 is a printed circuit board (PCB). The storage card 106 includes a series of electrical contacts, shown as contacts 142, extending from a front face of the board substrate 140. The contacts 142 are configured to electrically couple the storage card 106 to the controller 70 when the cartridge 100 is coupled to the housing 80. As shown, the storage card 106 includes four contacts 142. In other embodiments, the storage card 106 includes more or fewer contacts 142.

The storage card 106 includes a protrusion 144 coupled to the board substrate 140. The protrusion 144 extends forward from the front face of the board substrate 140. In some embodiments, the protrusion 144 is an electrical component. By way of example, the protrusion 144 may include a memory device, a capacitor, a resistor, and/or another electrical component. In other embodiments, the storage card 106 includes more or fewer protrusions 144.

The board substrate 140 defines a passage, recess, or aperture, shown as clip passage 146, extending through the board substrate 140. Specifically and in the example shown, the clip passage 146 extends completely through the board substrate 140, from a front face of the board substrate 140 to a rear face of the board substrate 140. The clip passage 146 is elongated, extending a distance W₁ in the lateral direction that is greater than a height of the clip passage 146 in the vertical direction. The protrusion extends a distance W₂ in the lateral direction. The distance W₁ is greater than the distance W₂, such that the clip passage 146 is wider than the protrusion 144. The clip passage 146 and the protrusion 144 are both substantially laterally centered on the board substrate 140, such that the clip passage 146 extends laterally beyond both sides of the protrusion 144.

The case 102 may be made from a variety of different materials, such as plastics, metals (e.g., steel, aluminum, etc.), and/or composites (e.g., fiberglass, carbon fiber, etc.). The case 102 may be made from a single material or multiple materials in combination. In some embodiments, the case 102 is formed from a relatively stiff or rigid material (e.g., a hard plastic or metal). The case 102 may provide the structure for supporting various other components of the cartridge 100, so selecting a rigid material for the case 102 may improve the structural integrity of the entire cartridge 100. Advantageously, this increased rigidity improves robustness during usage of the cartridge 100 with the printer.

In the example depicted, the case 102 is integrally formed such that the case 102 is a single, continuous piece of material (e.g., the case 102 is a unitary component). In this way, each of the plurality of walls including a neck interface for the bladder (described herein) and a bladder volume for receiving the bladder that is defined by at least some of the plurality of walls is formed of a single continuous piece of material. It should be understood that while the case is shown and described herein as a single continuous piece of material, additional components may be coupled to the case in certain implementations. Moreover and as shown herein, the neck interface is constructed or formed from the single piece of material (a single component) and not formed from multiple (e.g., two) components.

As an example, the case 102 may be injection molded or blow molded (and other types of plastic manufacturing processes), cast, or otherwise formed as a single, continuous piece of material. In one such embodiment, the case 102 is injection molded from plastic. By way of another alternative example, the case 102 may be initially formed from two or more separate pieces of material that are subsequently permanently attached or otherwise combined with one another (e.g., by welding, brazing, adhering, fastening, etc.). The single, continuous piece of material may be homogenous or non-homogenous (e.g., two sections of a first material connected by a second, adhesive material). By forming the case 102 as a single, continuous piece of material, the amount of assembly required to produce the cartridge 100 may be reduced relative to other cartridges that utilize cases assembled from two or more separate pieces. Additionally, an integrally formed case 102 may require less material than a case assembled from two or more separate pieces, reducing the cost of the cartridge 100 relative to other cartridges. An integrally formed case 102 increase the durability of the cartridge 100 (e.g., by reducing the likelihood of the case 102 splitting into multiple pieces). Such an increase in durability may reduce the amount of packing materials required when transporting the cartridge 100 relative to a more fragile case. Further, the integrally formed case 102 may eliminate parts associated with multi-component or part cases thereby alleviating inventory and assembly burdens (e.g., less parts to store and index as well as an easier assembly process due to the lesser amount of parts/components).

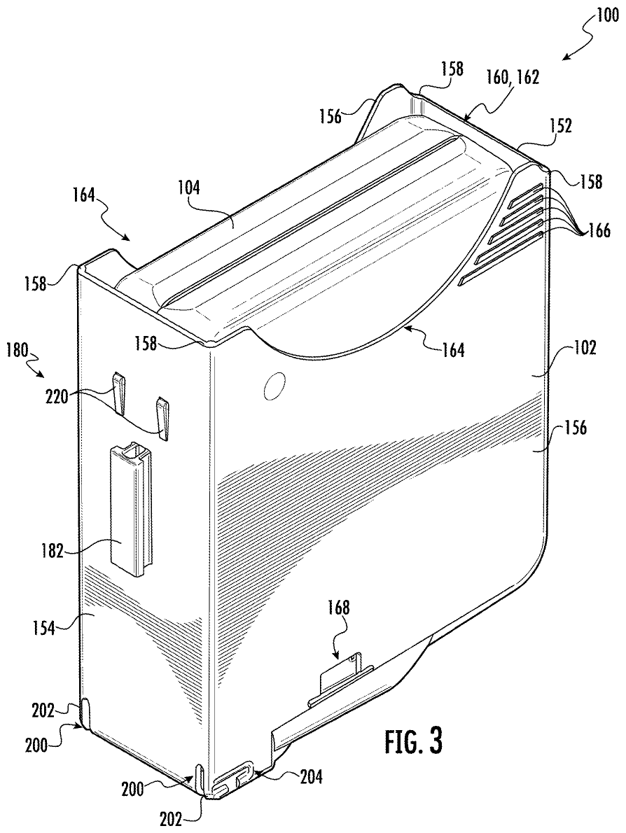

Referring to FIGS. 2 and 3, the case 102 includes a series of walls or panels. A first wall or panel, shown as front wall 150, extends laterally and vertically along a front side of the case 102. A second wall or panel, shown as top wall 152, extends laterally and longitudinally along a top side of the case 102. A third wall or panel, shown as bottom wall 154, extends laterally and longitudinally along a bottom side of the case 102. The top wall 152 is substantially parallel to the bottom wall 154. A pair of fourth walls or panels, shown as side walls 156, extend vertically and longitudinally along a right side and a left side of the case 102, respectively. The side walls 156 are substantially parallel to one another. The top wall 152, the bottom wall 154, and the side walls 156 are substantially perpendicular to the front wall 150 and extend longitudinally rearward from the front wall 150.

Referring to FIG. 3, the top wall 152 meets the side walls 156 along a first pair of longitudinal protrusions, shown as seams 158. Similarly, the bottom wall 154 meets the side walls 156 along a second pair of seams 158. Each seam 158 is thicker than the adjacent walls, extending inward from the walls. The seams 158 increase the rigidity of the case 102. Additionally, the seams 158 may act as a runner during the injection molding process, facilitating the flow of material to the walls and ensuring a complete filling of the case 102 with material. The seams 158 may also be referred to herein as interfaces, junctions, abutments, or intersection or intersection points. The seams 158 define an intersection area between adjacent walls of the case 102.

A volume (e.g., space, cavity, etc.), shown as bladder volume 160, is defined between the front wall 150, the top wall 152, the bottom wall 154, and the side walls 156. The bladder volume 160 is structured to receive and at least partially contain the bladder 104. Thus, the bladder volume 160 may be sized and shaped in a corresponding size and shape to the bladder 104, which can appreciably differ based on the implementation application as shown and described herein. An aperture or opening, shown as bladder aperture 162, is defined between the top wall 152, the bottom wall 154, and the side walls 156. The bladder aperture 162 extends along the rear side of the case 102. The bladder 104 is accessible (e.g., exposed to the surrounding environment) through the bladder aperture 162.

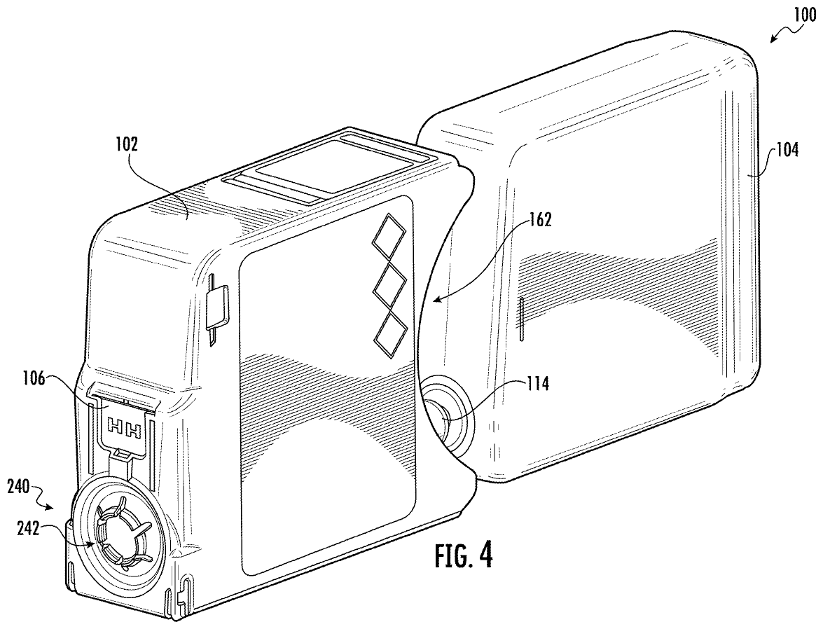

Referring to FIG. 4, the bladder aperture 162 facilitates insertion of the bladder 104 into the bladder volume 160. During installation, the bladder 104 is inserted through the bladder aperture 162, neck 114 first, until the bladder 104 is fully seated within the bladder volume 160. The position of the bladder aperture 162 also facilitates accommodating a variety of differently-sized bladders 104. FIGS. 7-9 illustrate the case 102 coupled to a variety of differently-sized bladders 104. In each of the embodiments, the same case 102 is utilized. The bladders 104 all have similar widths and heights, facilitating insertion into the bladder volume 160. Each of the bladders 104 has a different length in the longitudinal direction, such that the volume of each bladder 104 differs. Due to the placement of the bladder aperture 162 along the rear side of the case 102, the bladder aperture 162 permits the bladder 104 to extend through the bladder aperture 162 and rearward beyond, at least partly, the case 102. Accordingly, a single case 102 can accommodate bladders 104 of lengths longer than the case 102, and thus bladders 104 of a variety of volume sizes. The case 102 reduces the costs associated with providing a variety of differently-sized cartridges 100.

Referring to FIG. 3, each side wall 156 defines a relief, notch, groove, or cutout, shown as cutout 164. The cutout 164 extends completely laterally through the side wall 156, from an outer surface of the case 102 to an inner surface of the case 102. The cutout 164 extends longitudinally forward from a rear surface of the side wall 156 toward the front wall 150. The cutout 164 extends only partially longitudinally through the side wall 156, such that the cutout 164 does not reach the front wall 150. In other embodiments, the cutout 164 extends an entire length or height of the side wall 156. As shown in FIG. 3, the cutouts 164 each have a curved (e.g., semicircular, half moon, etc.) shape. In other embodiments, the cutouts 164 are otherwise shaped (e.g., triangular, rectangular, trapezoidal, etc.). In yet other embodiments, each side wall 156 includes multiple cutouts 164. Further and as shown, the cutouts 164 are identical in shape (i.e., mirror reflections of each other). In other embodiment, only cutout is implemented, the cutouts have different shapes and sizes, and/or another differing feature.

The cutouts 164 may reduce the amount of material required to form the case 102 thereby reducing the cost to produce the case 102. The cutouts 164 may facilitate a complete filling of the case 102 with material during the injection molding process. By way of example, the cutouts 164 may be placed away from the location where material is added to the case 102 during the injection molding process thereby reducing the distance that material is required to travel during the injection molding.

Referring to FIG. 11, the cartridge 100 is shown filled with fluid, according to an exemplary embodiment. The force of gravity on the fluid causes the fluid to force the bladder 104 outward, expanding the bladder 104 laterally. The expansion of the bladder 104 causes a corresponding lateral expansion of the case 102. As shown in FIG. 11, the portion of the case 102 that experiences the maximum lateral deflection is the area adjacent the cutouts 164. FIG. 11 illustrates the cutouts 164 in dashed lines and illustrates a version of the cartridge 100 without the cutouts 164 in solid lines. As shown, by adding the cutouts 164 to the case 102, the overall deflection of the case 102 when the bladder 104 is filled can be reduced.

Referring to FIG. 3, the case 102 includes a series of gripping features (e.g., protrusions, ribs, grooves, ridges, etc.), shown as ribs 166, extending outward from each of the side walls 156. The ribs 166 are oriented substantially vertically and are spaced longitudinally from one another. The ribs 166 are positioned near the top, rear corner of each side wall 156. The ribs 166 provide a textured area that facilitates a user gripping (e.g., by hand) the cartridge 100 to minimize slippage during installation and removal of the cartridge 100. By way of example, a user may place an index finger on one set of ribs 166 and a thumb the other set of ribs 166 and apply a pinching force on the case 102. The pinching force causes the ribs 166 to interlock with the user's fingers, enhancing the user's grip. The ribs 166 may also enhance the rigidity of the case 102.

Each of the side walls 156 defines an aperture or window, shown as fill level aperture 168, extending laterally through the side wall 156. Specifically, the fill level apertures 168 each extend from an outer surface of the case 102 to an inner surface of the case 102. As shown, the fill level apertures 168 are positioned adjacent the front wall 150 of the case 102. The fill level apertures 168 facilitate a visual confirmation of a fill level of the bladder 104. By way of example, when the bladder 104 is filled, the cartridge 100 may be oriented such that the neck 114 and the passage 116 extend upward (e.g., to prevent spillage). The bladder 104 may be filled with fluid through the passage 116, such that the bladder 104 fills from the rear end toward the front end. The bladder 104 may be visible through the fill level apertures 168, and the bladder 104 may be formed from transparent or translucent material so that a user or attendant may view the stored fluid in the bladder 104. When the bladder 104 reaches a desired fill level, the fluid may be visible through the bladder 104 and the fill level apertures 168, permitting a user to visually confirm when the bladder 104 has reached the desired fill level. In other embodiments, the fill level apertures 168 are otherwise positioned (e.g., to accommodate a different desired fill level).

Referring to FIG. 2, the case 102 may provide one or more markings 170 along one or more exterior surfaces of the case 102. The markings 170 may visually provide information to an observer, user, or attendant of the cartridge 100. The markings 170 may include numbers, images, and/or text. The markings 170 may communicate various information, such as information identifying the type of fluid contained within the cartridge 100, warnings, recycling instructions, logos identifying the manufacturer of the cartridge 100, or other information.

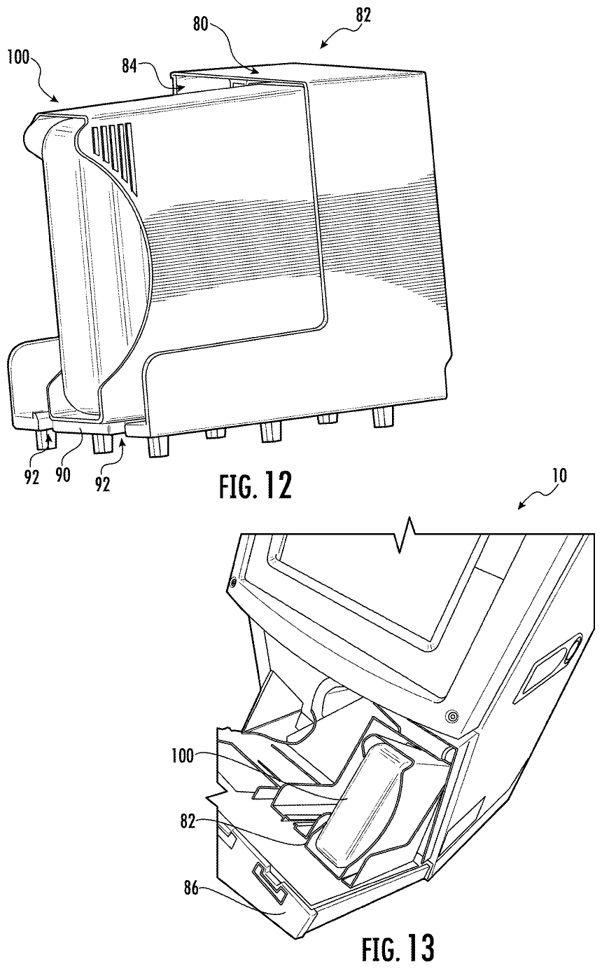

Referring to FIGS. 3 and 12, the case 102 further includes an attachment system or attachment interface, shown as mounting assembly 180, that is configured to engage a mounting bracket, shown as cartridge receiver 82. The cartridge receiver 82 is coupled to the housing 80 and configured to support a pair of cartridges 100 (e.g., the ink cartridge 20 and the solvent cartridge 30). The cartridge receiver 82 defines a pair of longitudinal recesses, shown as cartridge recesses 84, each sized to receive one of the cartridges 100. The mounting assembly 180 is configured to facilitate a selective coupling between each cartridge 100 and the cartridge receiver 82. The mounting assembly 180 may permit the cartridge 100 to be slid, and particularly slid longitudinally, into a cartridge recess 84 by pressing the cartridge 100 forward into the cartridge recess 84. Similarly, the mounting assembly 180 may permit the cartridge 100 to be slid out of the cartridge recess 84 by pulling the cartridge 100 backward out of the cartridge recess 84.

Referring to FIG. 13, the cartridge receiver 82 is coupled to a hinged portion of the housing 80, shown as door 86, according to an exemplary embodiment. The door 86 is pivotable about a lateral axis between an open position (e.g., shown in FIG. 13) and a closed position adjacent a main portion of the housing 80. Because the cartridge receiver 82 is coupled to the door 86, the cartridge(s) 100 move with the door 86 when the door 86 opens and closes. In the closed position, the door 86 prevents access to the cartridges 100, and the cartridges 100 are oriented with the passage 116 of the neck 114 extending vertically downward to facilitate draining the bladder 104. In the open position, the door 86 enables the cartridge(s) 100 to be accessed by a user (e.g., to permit adding or removing cartridges 100).

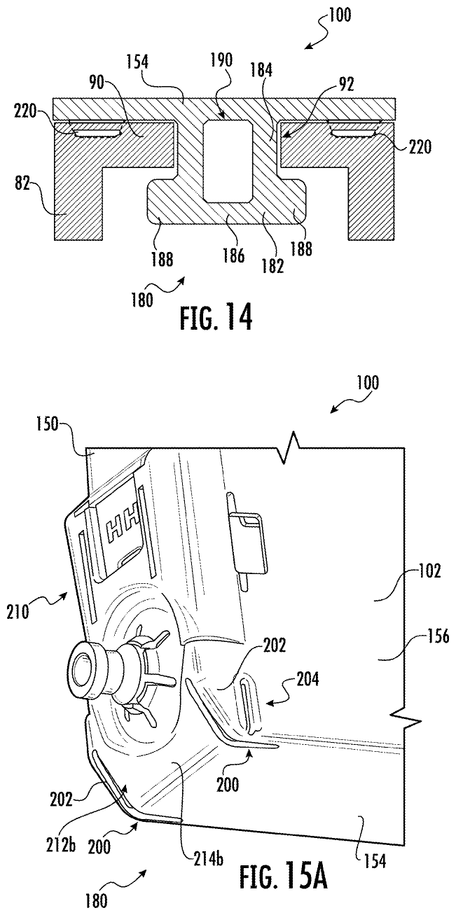

Referring to FIGS. 3 and 14, the mounting assembly 180 of the case 102 includes a first mounting feature, shown as mounting rail 182, according to an exemplary embodiment. The mounting rail 182 is approximately laterally centered on the bottom wall. The mounting rail 182 extends downward from the bottom wall 154 and longitudinally along the bottom wall 154. The mounting rail 182 has a generally T-shaped cross section. In other embodiments, the mounting rail 182 may have a different shape and structure. Specifically, the mounting rail 182 includes a narrow portion 184 and a wide portion 186. The narrow portion 184 extends between the bottom wall 154 and the wide portion 186. The wide portion 186 extends laterally beyond both sides of the narrow portion 184, forming a pair of overhanging flanges 188.

In some embodiments, a passage or recess, shown as passage 190, extends longitudinally through the narrow portion 184 and the wide portion 186. The passage 190 may extend partially or completely longitudinally through the mounting rail 182. The passage 190 may reduce the amount of material required to form the mounting rail 182.

Referring to FIGS. 12 and 14, a bottom wall 90 of the cartridge receiver 82 defines a pair of longitudinal slots or grooves, shown as rail slots 92. The rail slots 92 extend longitudinally forward from a rear surface of the bottom wall 90. Each rail slot 92 is approximately laterally centered on a corresponding cartridge recess 84. As shown in FIG. 14, when a cartridge 100 is assembled with the cartridge receiver 82, the mounting rail 182 is received within the corresponding rail slot 92. Specifically, the rail slot 92 receives the narrow portion 184. The bottom wall 90 of the cartridge receiver 82 is received between the bottom wall 154 of the case 102 and the wide portion 186 of the mounting rail 182. The narrow portion 184 engages the bottom wall 90 to limit or restrict lateral movement of the cartridge 100 relative to the cartridge receiver 82. The bottom wall 154 engages the bottom wall 90 to limit downward vertical movement of the cartridge 100 relative to the cartridge receiver 82. The wide portion 186 (specifically the overhanging flanges 188) engages the bottom wall 90 to limit upward vertical movement of the cartridge 100 relative to the cartridge receiver 82. Accordingly, the mounting rail 182 acts as a guide that permits longitudinal motion of the cartridge 100 while limiting movement in other directions.

Referring to cartridge of FIG. 3 (same as FIG. 2) and of FIGS. 15A and 15B which is varied related to FIG. 2, the mounting assembly 180 includes a pair of slots, shown as flange slots 200, that each extend inward from the front wall 150 and the bottom wall 154. The flange slots 200 each separate a portion of a side wall 156 from the front wall 150 and the bottom wall 154, forming an overhanging plate or extension, shown as detent flange 202. The flange slots 200 separate the detent flanges 202 from the front wall 150 and the bottom wall 154, permitting the detent flanges 202 to deflect (e.g., elastically deform) laterally inward). As described herein below, the cartridge of FIGS. 15A and 15B includes a relatively more pronounced relief area relative to that of FIG. 2 (and FIG. 3).

The case 102 defines a pair of divets, recesses, notches, or grooves, shown as detent recesses 204. Specifically, each detent recess 204 is defined by one of the detent flanges 202. The detent recesses 204 extend laterally inward from an outer surface of each side wall 156. In some embodiments, a thickness of an area surrounding each detent recess 204 is increased to increase a depth of the detent recess 204. The detent recesses 204 are positioned adjacent the front wall 150 and the bottom wall 154 of the case 102. The detent recesses 204 are vertically elongated.

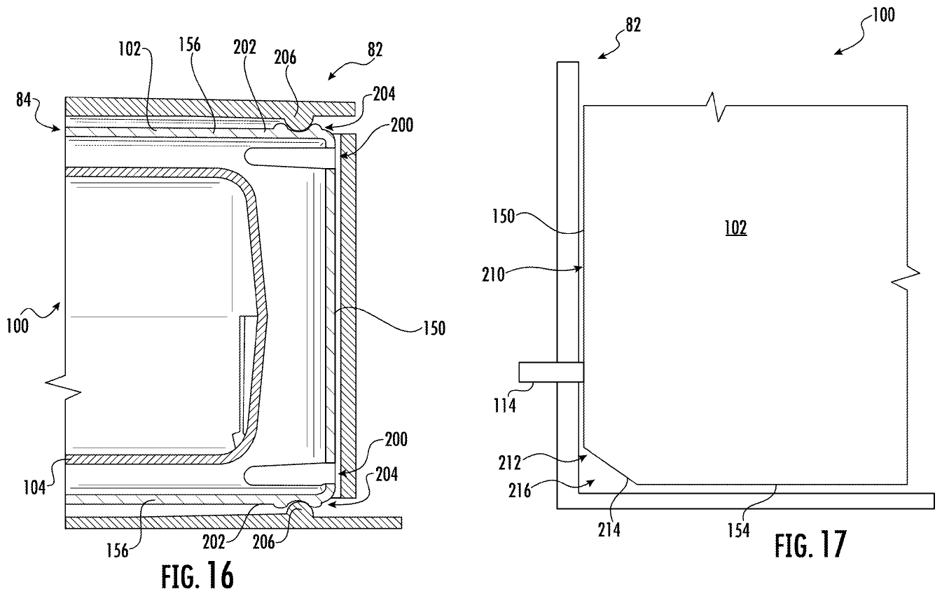

Referring to FIG. 16, the cartridge receiver 82 includes a pair of lateral protrusions, shown as detents 206, that extend laterally into each cartridge recess 84. By way of example, the detents 206 may be coupled to side walls of the cartridge receiver 82. The thickness of each detent 206 in the lateral direction varies as the detent 206 extends longitudinally. Specifically the thickness increases, then subsequently decreases, to form a smooth transition between the detent 206 and the sidewalls of the cartridge receiver 82. By way of example, the detents 206 may be semicircular, triangular, or otherwise tapered. The detents 206 are positioned to enter the detent recesses 204 when a cartridge 100 is seated within the cartridge recess 84. In this way, the positions of the detent recesses 204 define the location of a fully seated position of the cartridge 100 relative to the cartridge receiver 82.

To couple a cartridge 100 to the cartridge receiver 82, the cartridge 100 is pressed longitudinally inward into the cartridge recess 84. The detents 206 each engage one of the detent flanges 202. Due to the varying thickness of the detent 206, the longitudinal force on the cartridge 100 causes the detents 206 to deflect the detent flanges 202 inward. When the detent flanges 202 align with the detent recesses 204, the detent flanges 202 spring outward, capturing the detents 206 within the detent recesses 204. The spring forces of the detent flanges 202 resist the detents 206 from being removed from the detent recesses 204, thereby opposing movement of the cartridge 100 relative to the cartridge receiver 82. If a sufficient pulling force is applied on the cartridge 100 by the user, the spring forces of the detent flanges 202 may be overcome, and the cartridge 100 may be removed. Accordingly, the detents 206 and the detent flanges 202 facilitate removably coupling the cartridge(s) 100 to the cartridge receiver 82 without the use of tools.

Referring now to the relief area or volume provided by each of the cartridges 100 of FIGS. 15A and 15B and FIG. 2. Referring first to the cartridge of FIG. 2, the cartridge includes a lower portion 212a of the front wall 150. The lower portion 212a interconnects with the bottom wall 154 at a radius or curve that is inset relative to the flange slots 200 (i.e., offset relative to a front surface of the case 102). In other words, the flange slots 200 (and, particularly, the front wall 150 that defines the flange slots 200) extend further outward and away to the curved lower portion 212a. This structure defines a relief area or volume with the cartridge receiver 82 when the cartridge 100 is inserted into the receiver 82.

In comparison to the curved lower portion 212a of the cartridge of FIG. 2, referring to FIGS. 15A, 15B, and 17, the lower portion 212b of the front wall 150 of this cartridge 100 (particularly case 102) is angled inward toward the bladder receptacle and as such is also offset relative to a front surface of the case 102 (offset inward toward the bladder volume). In this regard, the front wall 150 of the case 102 includes a substantially vertical portion, shown as upper portion 210, and an angled portion or relief feature, shown as lower portion 212b. The neck 114 extends through the upper portion 210, and the lower portion 212b is positioned below the neck 114. The lower portion 212b extends between and connects the upper portion 210 and the bottom wall 154. The upper portion 210 extends within a first plane that is vertical or substantially vertical, and the bottom wall 154 extends within a second plane that is horizontal or substantially horizontal. The lower portion 212b is angled relative to the upper portion 210 and the bottom wall 154, such that the lower portion 212b is not parallel to the first plane or the second plane.

The lower portion 212a and 212b in each of the case 102 configurations defines an auxiliary surface or relief surface. In the case 102 of FIG. 2, the relief surface is shown as a curved surface. In the case 102 of FIG. 2, the relief surface is a curved surface, which is shown as curved surface 214a. In the case 102 of FIGS. 15A and 15B, the relief surface is an angled surface, which is shown as chamfer surface 214b. The curved surface 214a extends rearward and downward from the upper portion 210 of the front wall 150 to the bottom wall 154. The chamfer surface 214b extends rearward and downward from the upper portion 210 of the front wall 150 to the bottom wall 154. Accordingly, a distance between the chamfer surface 214b and the first plane of the upper portion 210 increases as the chamfer surface 214b extends toward the bottom wall 154. Similarly, a distance between the chamfer surface 214b and the second plane of the bottom wall 154 increases as the chamfer surface 214b extends toward the upper portion 210. In the case 102 of FIG. 2, a distance between the curved surface 214a of the lower portion 212 also increases as the surface gets closer to the bottom wall. The chamfer surface 214b prevents the upper portion 210 and the bottom wall 154 from meeting one another directly, thereby insetting a bottom front corner of the case 102. This is also shown with the curved surface 214a of the case of FIG. 2. It should be understood that the radius of curvature of the surface 214a may also change (e.g., increase or decrease) in other embodiments that employ a similar curved surface like the case 102 of FIG. 2.

In either the configuration of FIG. 2 or FIGS. 15A and 15B, when the cartridge 100 is fully seated within the cartridge recess 84 of the cartridge receiver 82, an empty space or volume, shown as a fluid buildup void 216, is defined between the chamfer surface 214b (curved surface 214a in FIG. 2) and the walls of the cartridge receiver 82. The fluid buildup void 216 is positioned vertically below the neck 114. During extended operation of the printer 10, multiple different cartridges 100 may be added to the printer 10, depleted of fluid, and removed. During this process, fluid from the neck 114 may drip down into the fluid buildup void 216 and solidify. Additionally, particulate matter may become lodged in this void or crevice. Without the inset provided by the chamfer surface 214b or curved surface 214a of the case 102 of FIG. 2 (i.e., the relief feature), this built up material could come into contact with the case 102 of FIG. 2 or FIGS. 15A and 15B and prevent the cartridge 100 from seating fully. With this relief feature, the fluid buildup void 216 (a similar, but different shaped void is created with the relief feature of FIG. 2) can contain a relatively large volume of built up material thereby preventing obstruction of the cartridge(s) 100 in the receiver 82 to enable relatively longer intended operation of the printer.

Referring to FIG. 3, the mounting assembly 180 further includes a set of inclined planar members, shown as ramps 220, positioned along the bottom wall 154 of the case 102. The ramps 220 each extend longitudinally along the bottom wall 154 and are laterally offset from one another 220. A front end of each ramp 220 that is closest to the front wall 150 is substantially flush with the bottom wall 154. A thickness of each ramp 220 in the vertical direction increases as the ramp 220 extends away from the front end to a rear end of the ramp 220.

Referring to FIGS. 3 and 14, during insertion of the cartridge 100 into the cartridge receiver 82, the ramps 220 engage the bottom wall 90 of the cartridge receiver 82. Specifically, the bottom wall 90 first engages the front ends of the ramps 220. As the cartridge 100 moves further into the cartridge recesses 84, the bottom wall 90 moves along the inclines of the ramps 220, forcing the rear end of the case 102 upward. This upward movement causes rotation of the case 102 about the mounting rail 182, which in turn causes the front wall 150 to rotate forward. By forcing the front wall 150 forward, the storage card 106 is also forced forward. This applies a positive pressure that engages the contacts 142 of the storage card 106 with a corresponding set of contacts in the cartridge receiver 82. Accordingly, the ramps 220 facilitate a consistent electrical connection between the storage card 106 and the printer 10.

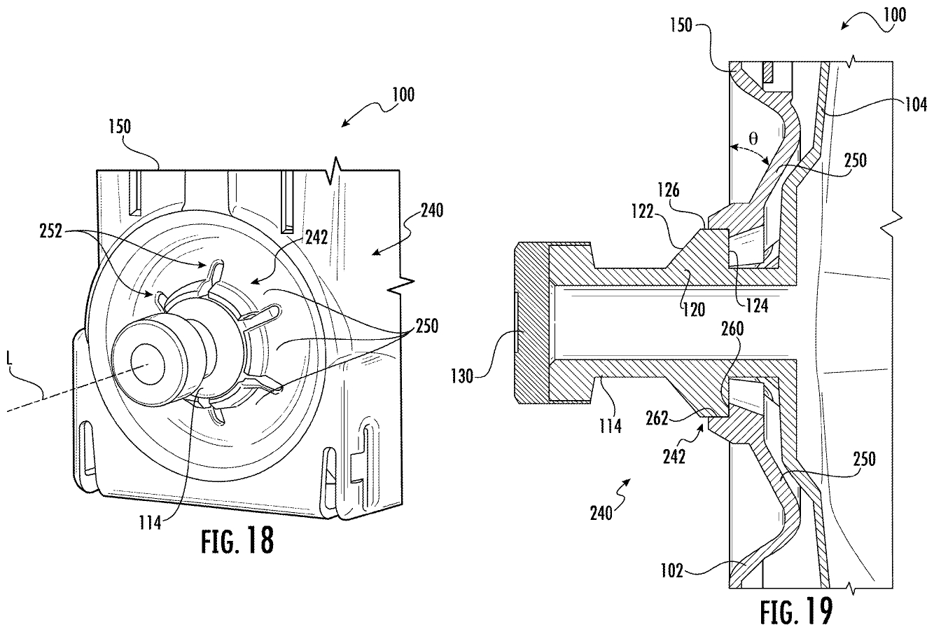

Referring to FIGS. 18 and 19, the case 102 includes a neck coupling portion, shown as neck interface 240, positioned along/on the front wall 150 of the case 102. The neck interface 240 is configured to couple the neck 114 of the bladder 104 to the case 102 and, particularly, retain or hold the neck 114 of the bladder 104 in a desired orientation/position. The neck interface 240 defines an aperture or passage, shown as neck aperture 242, through which the neck 114 extends through. The neck interface 240 engages the shoulder 120 of the neck 114, preventing the neck 114 from being pulled back through the neck aperture 242 and limiting longitudinal movement of the bladder 104 relative to the case 102.

The neck interface 240 includes a series of radial protrusions or members, shown as fingers 250, that extend radially inward toward a longitudinal centerline, “L,” of the neck 114. The fingers 250 are positioned proximate the neck passage and define, in part, the neck aperture 242. In this regard, the distal ends of the fingers 250 are equally spaced from the longitudinal centerline L to form the neck aperture 242. The fingers 250 are angularly spaced from one another at regular intervals such that notches, grooves, or gaps, shown as finger spaces 252, are formed between adjacent fingers 250. In the embodiment shown in FIG. 18, the neck interface 240 includes six fingers 250 and six finger spaces 252. In other embodiments, the neck interface 240 includes more or fewer fingers 250 and/or finger spaces 252.

The distal end portion of each finger 250 defines a pair of engagement surfaces, shown as engagement surface 260 and engagement surface 262. The engagement surface 260 extends substantially perpendicular to the longitudinal centerline L. The engagement surface 260 is positioned to engage the engagement surface 124 of the shoulder 120, limiting (e.g., preventing or substantially preventing) rearward longitudinal movement of the shoulder 120. The engagement surface 262 faces radially inward toward the longitudinal centerline L. The engagement surface 262 may have a substantially constant radius about the longitudinal centerline L. The engagement surface 262 is positioned to engage the outer surface 126 of the shoulder 120 thereby limiting radial movement of the neck 114. Because the fingers 250 surround the neck 114, the engagement between the engagement surfaces 262 and the outer surface 126 maintains the longitudinal alignment of the neck 114 relative to the case 102.

The fingers 250 each extend at an angle, θ, relative to the front surface of the case 102. In some embodiments, the angle θ is greater than zero degrees, such that the fingers 250 do not extend parallel to the front surface of the case 102. In some embodiments, the angle θ is less than 90 degrees, such that the fingers 250 do not extend perpendicular to the front surface of the case 102. In some embodiments, the angle θ is approximately 30 degrees. The fingers 250 extend longitudinally forward as the fingers 250 extend toward the longitudinal centerline L.

During installation of the bladder 104 into the case 102, the neck 114 is forced (e.g., pulled and/or pushed) longitudinally forward through the neck aperture 242. The tapered surface 122 engages the fingers 250, elastically bending, deflecting, outwardly flexing, or otherwise moving the fingers 250 outward and away from the neck 114 thereby expanding the neck aperture 242 to permit passage of the shoulder 120 through the neck aperture 242. The finger spaces 252 may facilitate relative movement of the fingers 250 to facilitate expansion of the neck aperture 242. When the shoulder 120 has moved beyond the ends of the fingers 250, the fingers 250 may bend back inward (e.g., due to the elastic deformation causing the fingers 250 to snap or move back to their original or substantially original position) and come into engagement with the shoulder 120. In this configuration, shown in FIG. 19, the engagement surfaces 260 of the fingers 250 engage the engagement surface 124 of the shoulder 120, and the engagement surfaces 262 of the fingers 250 engage the outer surface 126 of the shoulder 120. Contact between the fingers 250 and the shoulder 120 and contact between the front most wall 110 of the bladder 104 and the front wall 150 fixes the bladder 104 in place relative to the case 102.

In the event that a rearward longitudinal force is applied onto the neck 114 (e.g., by an attempt to extract the bladder 104 from the case 102), the rearward force is counteracted by the engagement surfaces 260 of the fingers 250. This introduces a moment loading onto the fingers 250 that attempts to cause rotation of the fingers 250. Due to the angled orientation of the fingers 250, in order for the fingers 250 to rotate rearward in this way, the ends of the fingers 250 would be required to move toward the longitudinal centerline L. This causes the engagement surfaces 262 to move radially inward, compressing the shoulder 120. As the rearward force on the neck 114 increases, the compressive force of the fingers 250 on the shoulder 120 also increases, strengthening the grip of the fingers 250 on the neck 114. Accordingly, due to the angled orientation of the fingers 250, the ability of the neck interface 240 to resist removal of the bladder 104 is enhanced.

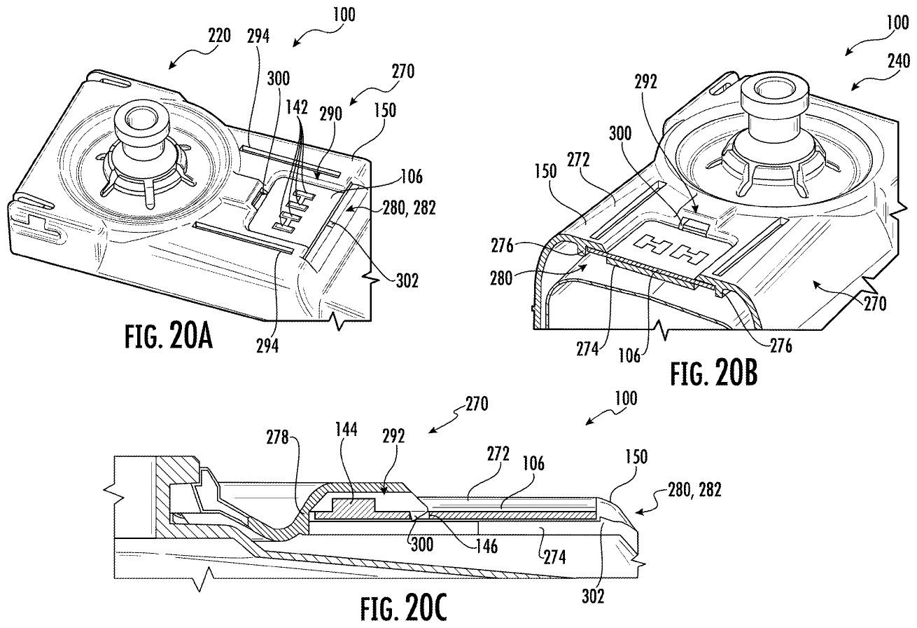

Referring to FIGS. 20A-20C, the case further includes a storage card coupling portion or storage card interface, shown as card interface 270, positioned along the front wall 150 of the case 102. Specifically, the card interface 270 is positioned directly above the neck interface 240. The card interface 270 is configured to selectively couple the storage card 106 to the case 102. The card interface 270 may be accessible from the exterior of the case, such that the storage card 106 can be inserted into the card interface 270 from outside of the case 102 and without removing the bladder 104. In some embodiments, the card interface 270 removably couples the storage card 106 to the case 102 thereby facilitating removal of the storage card 106 when disposing of a used cartridge 100. The card interface 270 may also facilitate removal of the storage card 106 in the event that the storage card 106 malfunctions and needs to be replaced.

The card interface 270 includes a series of walls, partitions, or supports that contain, hold, and support the storage card 106. Specifically, the card interface 270 includes (a) a frontmost wall, shown as outer wall 272, (b) a rearmost wall, shown as inner wall 274, (c) a pair of left and right side walls, shown as side rails 276, and (d) a bottommost wall, shown as bottom wall 278. Together, the outer wall 272, the inner wall 274, the side rails 276, and the bottom wall 278 define a recess or slot, shown as card pocket 280, that receives the storage card 106. The card pocket 280 may be accessed through an upward-facing opening, shown as card pocket aperture 282. The card pocket aperture 282 extends between and is defined by the outer wall 272, the inner wall 274, and the side rails 276.

The storage card 106 may be inserted vertically downward into the card pocket 280 through the card pocket aperture 282. Because the card pocket aperture 282 is positioned on the exterior of the case 102, the storage card 106 may be inserted and/or removed from the case 102 at any time, regardless of an assembly state of the cartridge 100. By way of example, the storage card 106 may be inserted and/or removed from the case 102 regardless of whether or not the bladder 104 has been coupled to the case 102. This capability facilitates flexibility in manufacturing the cartridge 100, as the storage card 106 can be added to the cartridge 100 at any point in time after the case 102 has been formed.

Once the storage card 106 is contained within the card pocket aperture 282, the walls of the card interface 270 engage the storage card 106 to limit (e.g., prevent) movement of the storage card 106 relative to the case 102. The outer wall 272 engages the front side of the storage card 106 to limit forward longitudinal movement of the storage card 106. The inner wall 274 engages the rear side of the storage card 106 to limit rearward longitudinal movement of the storage card 106. The side rails 276 engage the left and right sides of the storage card 106 to limit lateral movement of the storage card 106. The bottom wall 278 engages the bottom side of the storage card 106 to limit downward vertical movement of the storage card 106.

The outer wall 272 of the card interface 270 defines a recess or aperture, shown as contact cutout 290. The contact cutout 290 extends along the front surface of the case 102. As shown, the contact cutout 290 is continuous with the card pocket aperture 282. The contact cutout 290 provides clearance for the contacts 142 when the storage card 106 is inserted into the card pocket 280, preventing damage from contact between the contacts 142 and the case 102. Additionally, when the storage card 106 is fully seated within the card pocket 280, the contact cutout 290 prevents the case 102 from obstructing access to the contacts 142, and facilitating access to the contacts 142 by the printer 100.

A portion of the outer wall 272 extends forward to define a recess, shown as protrusion recess 292, that faces upward and rearward. The protrusion recess 292 is laterally centered relative to the card pocket 280, such that the protrusion recess 292 receives the protrusion 144 of the storage card 106 when the storage card 106 is fully inserted into the card pocket 280. The protrusion recess 292 provides clearance for the protrusion 144, such that outer wall 272 does not interfere with the protrusion 144 during insertion of the storage card 106. The portion of the outer wall 272 that defines the protrusion recess 292 may also extend in front of the protrusion 144 to protect the protrusion 144 from undesirable contact (e.g., impacts) with other objects.

The outer wall 272 further defines a pair of elongated passages, slots, or slits, shown as face slots 294. The face slots 294 are elongated in a vertical direction and extend longitudinally through the outer wall 272. The face slots 294 are positioned on opposite sides of the contact cutout 290. The face slots 294 are each positioned directly adjacent one of the side rails 276. The face slots 294 may facilitate injection molding of the case 102. Specifically, the shape of the case 102 may be shaped during injection molding by a mold. The face slots 294 may facilitate insertion of a portion of the mold that forms the side rails 276. Without the face slots 294, the mold might not otherwise be able to reach into the card pocket 280 to define the side rails 276.

The card interface 270 includes a pair of catches, retainers, or angled protrusions, shown as clips 300. Each clip 300 includes a generally horizontal surface that faces downward and an angled surface that faces upward. Specifically, the angled surface extends forward as the angled surface extends upward. The clips 300 are coupled to the outer wall 272 and extend longitudinally rearward from the outer wall 272. The clips 300 are positioned on opposite sides of the protrusion recess 292. The clips 300 are arranged at approximately the same vertical position. The clips 300 are positioned to be received within the clip passage 146 of the storage card 106 when the storage card 106 is fully inserted into the card pocket 280. During insertion of the storage card 106, a bottom edge of the storage card 106 engages the angled surface of each clip 300. Engagement of the storage card 106 with the angled surfaces causes the clips 300 to deflect longitudinally forward, away from the storage card 106, permitting the storage card 106 to move downward. When the clips 300 reach the clip passage 146, the clips 300 enter into the clip passage 146. If an upward force is then applied to the storage card 106, the storage card 106 engages the generally horizontal surfaces of the clips 300 and is held in place. Accordingly, the clips 300 resist removal of the storage card 106.

The card interface 270 includes another catch or retainer, shown as clip 302. The clip 302 includes a generally horizontal surface that faces downward and an angled surface that faces upward. Specifically, the angled surface extends rearward as the angled surface extends upward. The clip 302 is coupled to the inner wall 274 and extends longitudinally forward from the inner wall 274. The clip 302 is approximately laterally centered about the card pocket 280. The clip 302 is positioned above the storage card 106 when the storage card 106 is fully inserted into the card pocket 280. During insertion of the storage card 106, a bottom edge of the storage card 106 engages the angled surface of the clip 302. Engagement of the storage card 106 with the angled surfaces causes the clip 302 to deflect longitudinally rearward, away from the storage card 106, permitting the storage card 106 to move downward. When the clip 300 reaches the top surface of the storage card 106, the clip 302 moves into position above the storage card 106. If an upward force is then applied to the storage card 106, the storage card 106 engages the generally horizontal surface of the clip 302 and is held in place. Accordingly, the clip 302 resists removal of the storage card 106.

In some embodiments, the storage card 106 is selectively removable from the card interface 270. In some embodiments, the storage card 106 may be slid out of the card pocket 280 by deflecting the clips 300 and 302 away from the storage card 106. A user may apply a forward longitudinal force on the clips 300 to disengage the clips 300 from the storage card 106. A user may also apply a rearward longitudinal force on the clip 302 to disengage the clip 302 from the storage card 106. Once disengaged, the clips 300 and 302 may permit the storage card 106 to be slid upward, out of the card pocket 280. Removably coupling the storage card 106 to the card interface 270 may facilitate removal of the storage card 106 when disposing of the cartridge 100 (e.g., to facilitate recycling of two different materials). Removably coupling the storage card 106 to the card interface 270 may also facilitate replacement of the storage card 106 if the storage card 106 malfunctions, or with a storage card 106 containing different data.

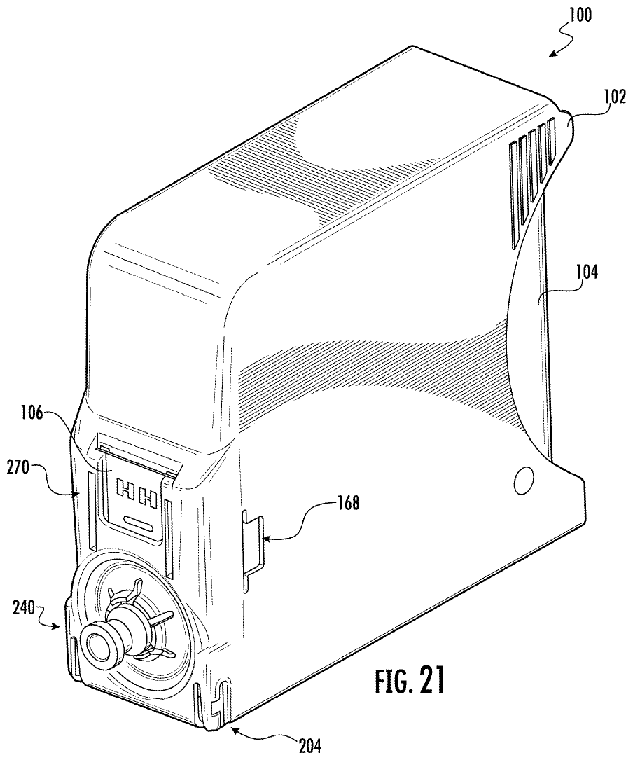

FIG. 21 depicts a variation of the cartridge 100 relative to the cartridge in FIGS. 2-4, 7-9, and 18-23. The cartridge 100 of FIG. 21 is substantially similar, in structure and function, to the cartridge 100 in FIGS. 2-4, 7-9, and 18-23 except for including a card interface 270 that is a variation on the card interface 270 shown in FIGS. 20A-20C. Therefore, the description contained below and herein regarding the cartridge of FIG. 2 is equally applicable to that of FIG. 21 except as otherwise described herein.

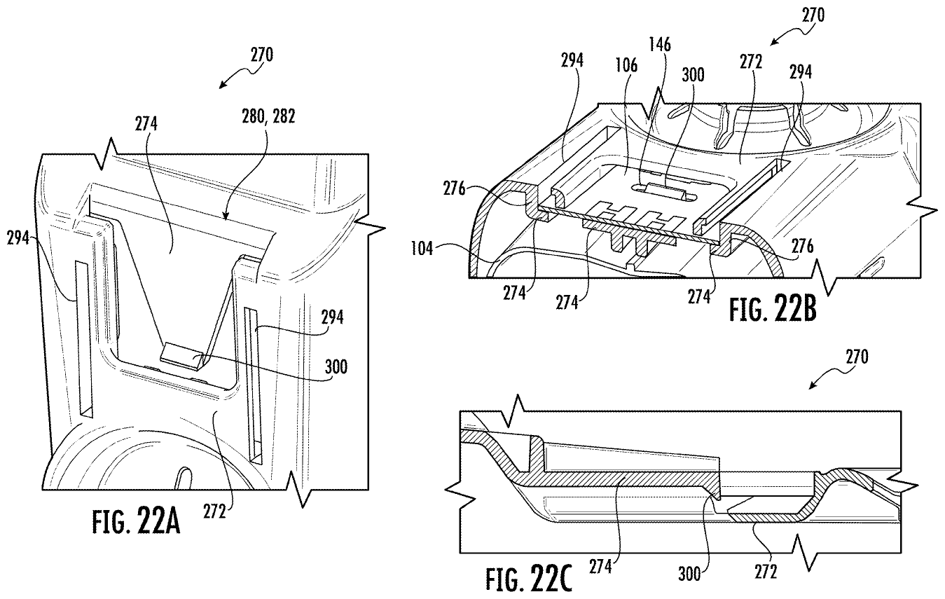

Referring to FIGS. 22A-22C, the card interface 270 of the cartridge 100 of FIG. 21 is shown. The card interface 270 of FIGS. 22A-22C may be substantially similar to the card interface 270 of FIGS. 20A-20C except as otherwise specified herein. In this way, these alternative card interfaces may be used or implemented with one or more of the cases described herein. The card interface 270 includes a single clip 300 that is coupled to the inner wall 274. The clip 300 extends forward from the inner wall 274 and through the clip passage 146 of the storage card 106.

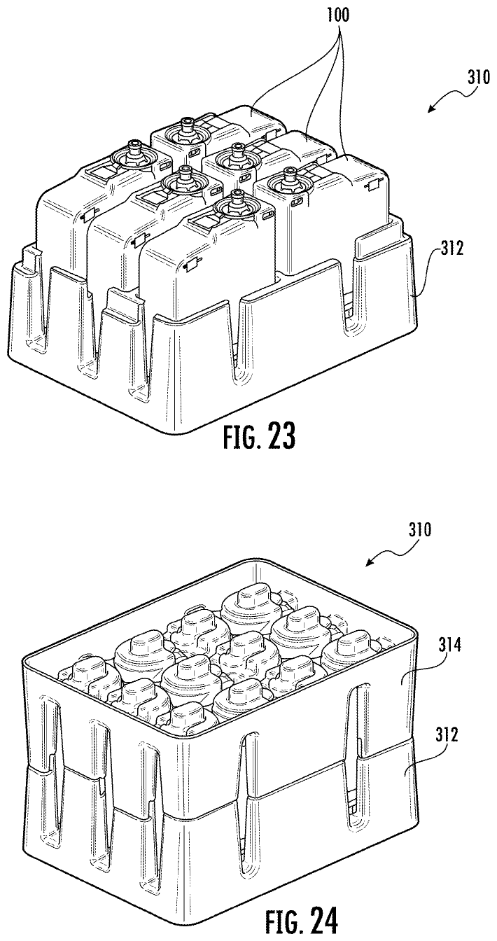

Referring to FIGS. 23 and 24, a cartridge package or container, shown as package 310, is configured to contain one or more cartridges 100. The package 310 may be used during shipping to protect the cartridges 100, such as from impacts with other objects. The package 310 includes a first portion, shown as bottom portion 312, and a second portion, shown as top portion 314. The bottom portion 312 may interlock or otherwise engage with the top portion 314 to removably couple the top portion 314 to the bottom portion 312. The top portion 314 and the bottom portion 312 define a containment volume therebetween that receives the cartridges 100. With the top portion 314 coupled to the bottom portion 312, the package 310 substantially surrounds the cartridges 100. As shown, the package 310 is configured to contain up to six cartridges 100. In other embodiments, the package 310 is configured to contain more or fewer cartridges 100.

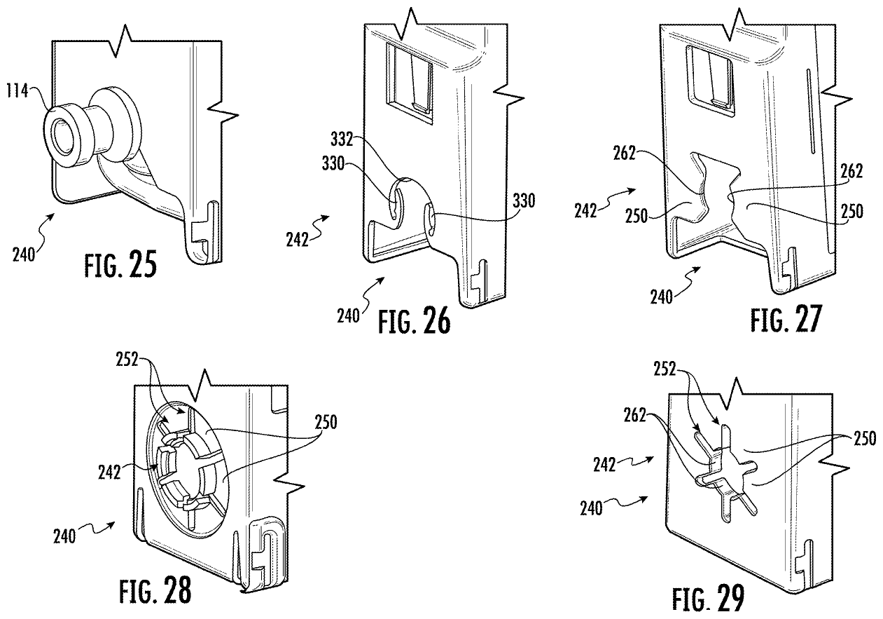

Referring to FIGS. 25-29, the neck interface 240 is shown according to various additional alternative embodiments. The neck interfaces 240 of FIGS. 25-29 may be substantially similar to the neck interface of FIGS. 18 and 19 except as otherwise specified herein. As such, the neck interface 240 may be implemented with one or more of the cases described herein. FIGS. 25 and 26 illustrate a neck interface 240 according to a first alternative embodiment. In this embodiment, the fingers 250 are omitted and replaced with a pair of biasing elements, shown as spring fingers 330, and an engagement surface 332 defined by the front wall 150. The neck aperture 242 is only partially enclosed, such that the neck aperture 242 opens downward. The spring fingers 330 are positioned at opposite lateral sides of the neck aperture 242. The engagement surface 332 is positioned at an upper end of the neck aperture 242 and faces downward. To engage the neck 114 with the neck interface 240, the neck 114 is forced upward into the neck aperture 242. The neck 114 deflects the spring fingers 330 laterally outward. As the center of the neck 114 passes between the spring fingers 330, the spring fingers 330 move toward one another and apply an upward biasing force on the neck 114. The engagement surface 332 engages the top of the neck 114, such that the neck 114 is captured between the engagement surface 332 and the spring fingers 330.

Referring to FIG. 27, the neck interface 240 is shown according to another exemplary embodiment. In this embodiment, the neck interface 240 includes two fingers 250 that each define an engagement surface 262. The neck aperture 242 is only partially enclosed, such that the neck aperture 242 opens downward. To engage the neck 114 with the neck interface 240, the neck 114 is forced upward into the neck aperture 242. The engagement surfaces 262 of the fingers 250 engage the neck 114 to hold the neck 114 in place.

Referring to FIG. 28, the neck interface 240 is shown according to another exemplary embodiment. In this embodiment, the fingers 250 reside within the vertical plane of the front wall 150. Accordingly, the angle θ is zero or substantially zero degrees. Referring to FIG. 29, the neck interface 240 is shown according to another exemplary embodiment. The neck interface 240 of FIG. 29 does not include the engagement surfaces 260 in this example embodiment.

Referring to FIGS. 30-36, the card interface 270 is shown according to various alternative embodiments. The card interfaces 270 of FIGS. 30-36 may be substantially similar to the card interface 270 of FIGS. 20A-20C or 22A-22C except as otherwise specified herein. In this way, these alternative card interfaces may be used or implemented with one or more of the cases described herein. FIG. 30 illustrates a card interface 270 according to a first embodiment. In this embodiment, the front wall 150 defines a recess or pocket, shown as card recess 350. The card recess 350 extends longitudinally rearward into the front wall 150. The card recess 350 may be sized to receive the board substrate 140. A second recess or pocket, shown as protrusion recess 352, extends longitudinally rearward into the front wall 150. The protrusion recess 352 extends rearward beyond the card recess 350. The protrusion recess 352 may be sized to receive the protrusion 144. Accordingly, the protrusion recess 352 may be smaller than the card recess 350. When installing the storage card 106 into the card interface 270, the storage card 106 is moved longitudinally rearward until the protrusion recess 352 receives the protrusion 144 and the card recess 350 receives the board substrate 140. The storage card 106 may be held in place by adhesive, a fastener, or another type of coupler.

Referring to FIG. 31, the card interface 270 is shown according to another exemplary embodiment. The card interface 270 of FIG. 31 further defines an additional recess, shown as inset 354. The inset 354 extends between the card recess 350 and the outer surface of the front wall 150. The inset 354 may set the storage card 106 further rearward to provide additional protection from collision with external debris.

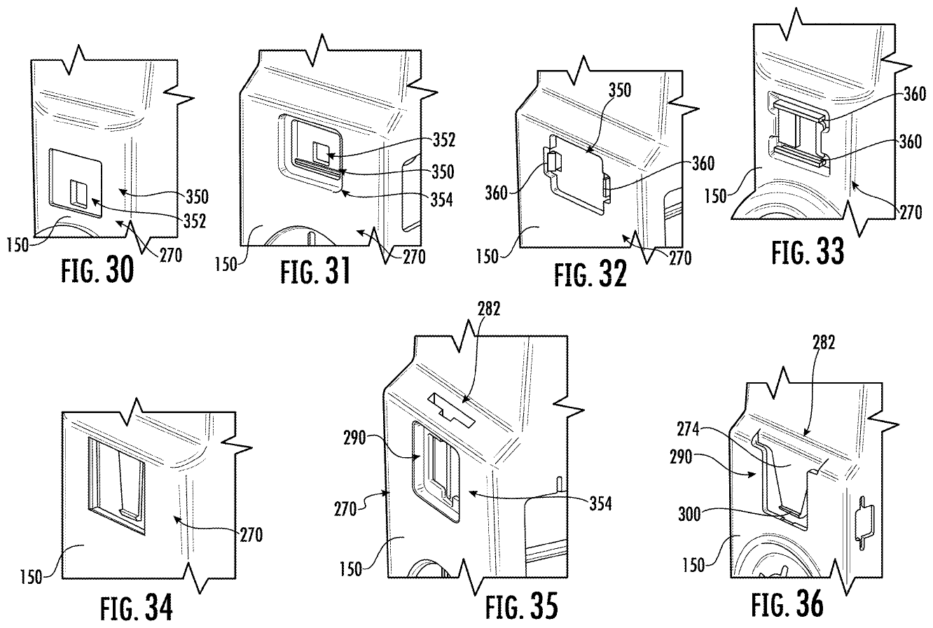

Referring to FIG. 32, the card interface 270 is shown according to another exemplary embodiment. The card interface 270 of FIG. 32 includes a pair of retainers, shown as clips 360. The clips 360 are positioned on the left and right sides, respectively, of the card recess 350. The clips 360 are positioned to engage the left and right sides of the storage card 106 to retain the storage card 106 in the card recess 350. FIG. 33 illustrates a similar embodiment in which the clips 360 are positioned to engage the top and bottom sides of the storage card 106. FIG. 34 illustrates a similar embodiment including a single clip 360 that engages the storage card 106.

Referring to FIG. 35, the card interface 270 is shown according to another exemplary embodiment. In the card interface 270 of FIG. 35, the contact cutout 290 and the card pocket aperture 282 are separated from one another by a portion of the front wall 150. Additionally, an inset 354 extends between the card pocket aperture 290 and the outer surface of the front wall 150. Referring to FIG. 36, the card interface 270 is shown according to another exemplary embodiment. In the card interface 270 of FIG. 36, a single clip 300 extends longitudinally forward from the inner wall 274. Additionally, the face slots 294 are omitted from the card interface 270 of FIG. 36.

Referring to FIGS. 37-48, various alternative additional embodiments of the cartridge 100 are shown. The cartridges 100 of FIGS. 37-48 may be substantially similar to the cartridge 100 of FIG. 2 except as otherwise specified herein. As can be appreciated, a variety of different shapes, sizes, and features employed with the cartridge 100 and, particularly case 102, such that the case 102 may be shaped and sized in a variety of different ways. Referring to FIG. 37, a cartridge 100 is shown according to another exemplary embodiment. The case 102 of the cartridge 100 includes a series of structural reinforcements, shown as ribs 400. The ribs 400 extend longitudinally forward from the rear side of the case 102. The ribs 400 may be formed by bending the side walls 156 laterally inward or laterally outward. The ribs 400 may increase the rigidity of the case 102.

Referring to FIG. 38, the cartridge 100 is shown according to another exemplary embodiment. In the cartridge 100 of FIG. 38, the shape and quantity of the cutouts 164 differs from that of the cartridge 100 of FIG. 2. Specifically, the case 102 of the cartridge 100 of FIG. 38 has cutouts 164 along the left and right sides, as well as the top side of the case 102. Additionally, the cutouts 164 along the left and right sides are continuous with the cutout 164 along the top side of the case 102.

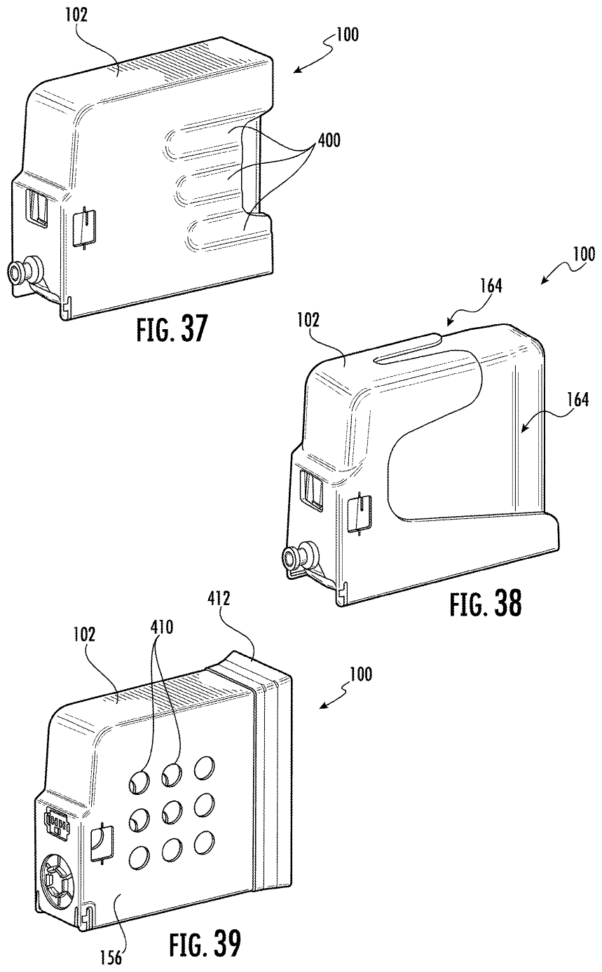

Referring to FIG. 39, the cartridge 100 is shown according to another exemplary embodiment. In the cartridge 100 of FIG. 39, the side walls 156 define a series of passages, shown as side wall apertures 410. The side wall apertures 410 extend laterally and completely through the side walls 156. The side wall apertures 410 may reduce the amount of material required to form the case 102. The case 102 of FIG. 39 omits the cutouts 164. A reinforcement or structural rib, shown as rib 412, extends along the side walls 156, the top wall 152, and the bottom wall 154 at the rear end of the case 102. The rib 412 is thicker than the side walls 16, the top wall 152, and the bottom wall 154. Accordingly, the rib 412 may increase the rigidity of the case 102.

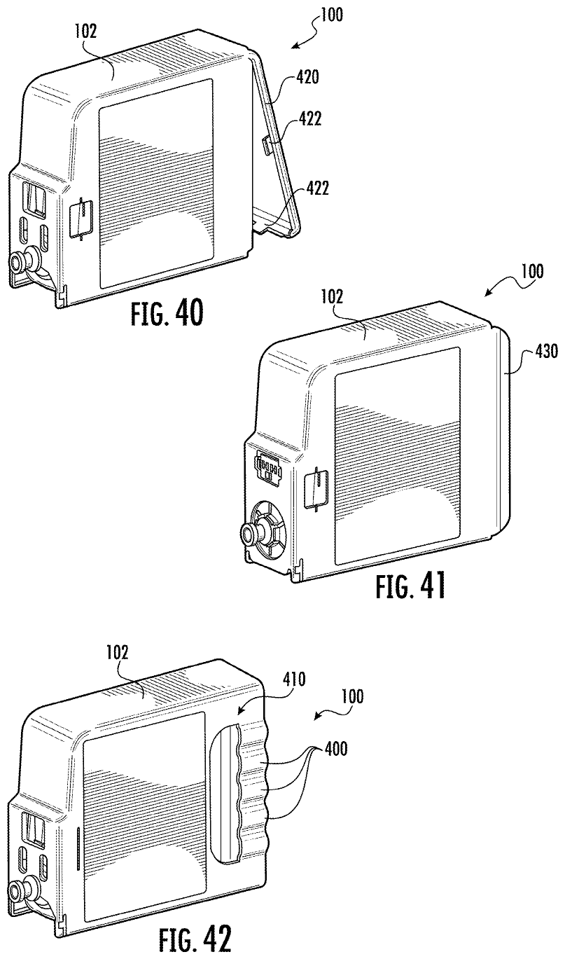

Referring to FIG. 40, the cartridge 100 is shown according to another exemplary embodiment. In the cartridge 100 of FIG. 40, the case 102 includes a movable member, shown as door 420, coupled to the top wall 152. The door 420 is pivotable about a lateral axis between an open position and a closed position. When in the closed position, a series of clips 422 on the door 420 engage the side walls 156 and the bottom wall 154, holding the door 420 closed. When in the closed position, the door 420 increases the rigidity of the case 102.

Referring to FIG. 41, the cartridge 100 is shown according to another exemplary embodiment. In the cartridge 100 of FIG. 41, the case 102 includes a pair of flanges, shown as reinforcement flanges 430. Each reinforcement flange 430 is coupled to one of the side walls 156 and extends rearward and laterally outward from the corresponding side wall 156. The reinforcement flanges 430 may increase the rigidity of the case 102.

Referring to FIG. 42, the cartridge 100 is shown according to another exemplary embodiment. In the cartridge 100 of FIG. 42, each side wall 156 defines a single side wall aperture 410 that is vertically elongated. Each side wall 156 also includes a series of ribs 400 that extend between the side wall aperture 410 and the rear end of the case 102.

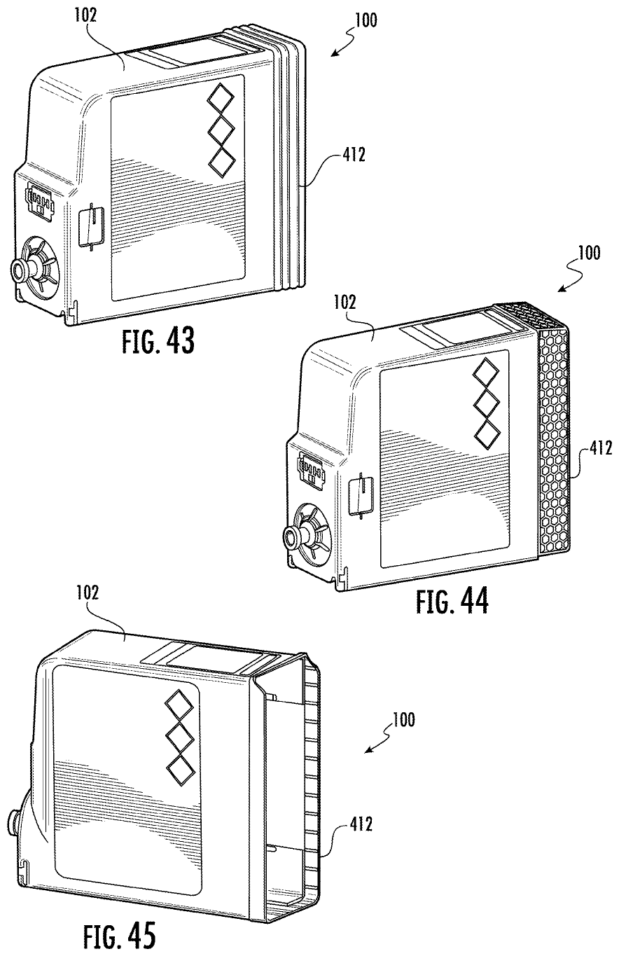

Referring to FIGS. 43-45, the cartridge 100 is shown according to other exemplary embodiments. The cartridges 100 of FIGS. 43-45 all include ribs 412 of differing shapes. In the cartridge 100 of FIG. 43, the rib 412 includes a series of concentric and longitudinally offset rings. In the cartridge 100 of FIG. 44, the rib 412 includes a honeycomb pattern. In the cartridge 100 of FIG. 45, the rib 412 includes a series of longitudinal reinforcement matters.

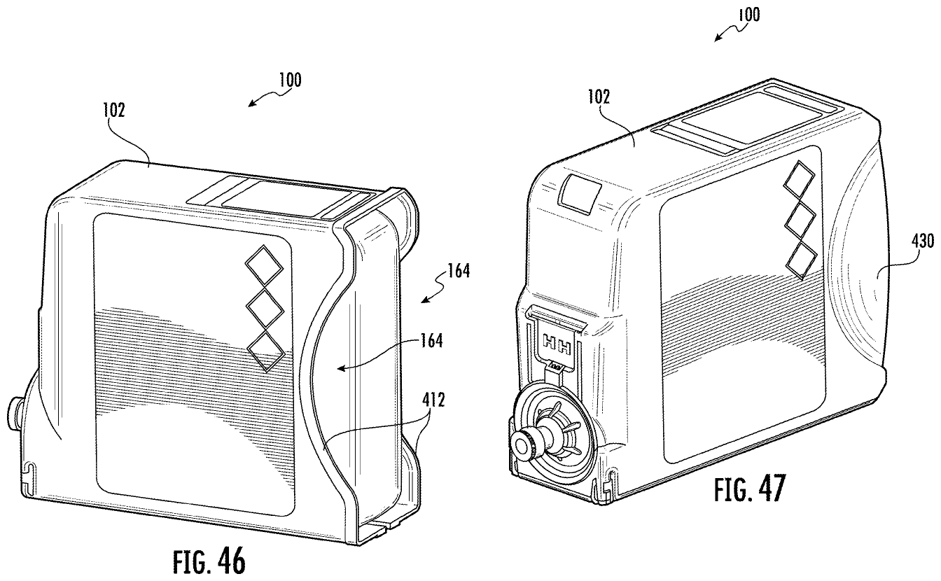

Referring to FIG. 46, the cartridge 100 is shown according to another exemplary embodiment. In the cartridge 100 of FIG. 46, each side wall 156 includes a rib 412 that extends along the edge of the cutouts 164. Referring to FIG. 47, the cartridge 100 is shown according to another exemplary embodiment. In the cartridge 100 of FIG. 47, each side wall 156 includes a flange 430. The front edge of each flange 430 is curved, similar to the front edge of the cutout 164 of FIG. 2.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above.

It is important to note that the construction and arrangement of the printer as shown in the various exemplary embodiments is illustrative only. Additionally, any element disclosed in one embodiment may be incorporated or utilized with any other embodiment disclosed herein. For example, the neck interface 240 of the exemplary embodiment shown in at least FIG. 25 may be incorporated in the cartridge 100 of the exemplary embodiment shown in at least FIG. 2. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A case for a cartridge of a printer, the case comprising:
a plurality of walls defining a bladder volume configured to receive a bladder of the cartridge; and
a neck interface of a front wall of the plurality of walls, the neck interface defining a neck aperture configured to receive a neck of the bladder,
wherein the case is a single continuous piece of material.

2. The case of claim 1, wherein the neck interface includes a plurality of fingers coupled to the front wall, the plurality of fingers being positioned to engage the neck of the bladder.

3. The case of claim 2, wherein each of the plurality of fingers are angled relative to the front wall such that the fingers extend longitudinally forward and toward a longitudinal centerline of the neck aperture.

4. The case of claim 3, wherein a first finger of the plurality of fingers includes an engagement surface that extends substantially parallel to the front wall and that is positioned to engage the neck of the bladder.

5. The case of claim 4, wherein the engagement surface is a first engagement surface, and wherein the first finger includes a second engagement surface that faces toward the longitudinal centerline of the neck aperture and that is positioned to engage the neck of the bladder.

6. The case of claim 1, further comprising a storage card interface positioned along the front wall and configured to couple a storage card to the case.

7. The case of claim 6, wherein the storage card interface defines a recess that is configured to receive the storage card, the recess extending rearward from an exterior surface of the front wall of the case.

8. The case of claim 7, wherein the storage card interface includes an inner wall offset rearward from the front wall, wherein the inner wall at least partially defines the recess that is configured to receive the storage card.

9. The case of claim 8, wherein the storage card interface further includes a clip coupled to the inner wall and extending away from the inner wall and into the recess, wherein the clip is positioned to engage the storage card to resist removal of the storage card from the storage card interface.

10. The case of claim 6, wherein the neck interface includes a plurality of fingers coupled to the front wall, the plurality of fingers being positioned to engage the neck of the bladder.

11. The case of claim 1, wherein the plurality of walls further includes a top wall, a bottom wall, and a pair of side walls extending rearward from the front wall, and wherein the top wall, the bottom wall, and the side walls define a bladder aperture configured to receive the bladder therethrough.

12. A method of manufacturing a cartridge for a printer, the cartridge having a case defining a bladder volume and including a neck aperture positioned on a first side of the case and the cartridge having a bladder including a main body configured to hold a fluid and having a neck coupled to the main body, the method comprising:
positioning the bladder such that the neck extends through the neck aperture and the main body extends within the bladder volume; and
moving at least one member of the case proximate the neck aperture away from the neck during the positioning,
wherein the case is a single continuous piece of material.

13. The method of claim 12, wherein the case includes a bladder aperture positioned on a second side of the case opposite the first side, the method further comprising inserting the bladder through the bladder aperture.

14. The method of claim 12, further comprising engaging a storage card with a storage card interface of the case to couple the storage card to the case.

15. The method of claim 14, wherein the storage card interface defines a recess, wherein engaging the storage card with the storage card interface includes inserting the storage card into the recess of the storage card interface.

16. The method of claim 15, further comprising inserting a clip of the case into a clip aperture defined by the storage card such that the clip engages the storage card to resist removal of the storage card from the recess.

17. The method of claim 12, further comprising offsetting a lower portion of the first side of the case relative to at least a part of a remaining portion of the first side of the case.

18. A single component case for a cartridge of a printer, the single component case comprising:
a plurality of walls defining a bladder volume configured to receive a bladder of the cartridge; and
a neck interface of a front wall of the plurality of walls, the neck interface defining a neck aperture configured to receive a neck of the bladder.

19. The single component case of claim 18, wherein the plurality of walls includes a side wall extending rearward from the front wall, wherein the side wall partially defines an aperture configured to receive the bladder therethrough.

20. The single component case of claim 18, wherein the neck interface includes a plurality of fingers extending toward a longitudinal centerline of the neck aperture, and wherein the neck aperture is defined between the fingers.
